(19) United States
(12) Patent Application Publication
(10) Pub. No.: US 2020/0226225 A1
(43) Pub. Date: Jul. 16, 2020

(54) Offboard Vehicle Service Testing System

(71) Applicant: Uber Technologies, Inc., San Francisco, CA (US)

(72) Inventors: Vladimir Zaytsev, San Francisco, CA (US); Leigh Gray Hagestad, San Francisco, CA (US); Andrii Iasynetskyi, Millbrae, CA (US)

(21) Appl. No.: 16/517,861

(22) Filed: Jul. 22, 2019

Related U.S. Application Data
(60) Provisional application No. 62/797,040, filed on Jan. 25, 2019.
(60) Provisional application No. 62/790,827, filed on Jan. 10, 2019.

(51) Int. Cl. G06F 17/50; G05D 1/00; G01M 17/00; G07C 5/00; H04W 4/40

(52) U.S. Cl. CPC G06F 17/5009; G05D 1/0088; G05D 2201/0213; G07C 5/008; H04W 4/40; G01M 17/00

(57) ABSTRACT

Systems and methods for autonomous vehicle service assignment simulation are provided. In one example embodiment, a computer-implemented method includes obtaining data indicative of an autonomous vehicle to be tested within a simulation associated with a service entity, and generating a simulation environment for the simulation and a simulated autonomous vehicle within the simulation environment based at least in part on the data indicative of the autonomous vehicle. The method includes accessing one or more backend systems of the service entity via an application programming interface platform having one or more functional calls defined to be accessed by a third-party autonomous vehicle or a managing entity of third-party autonomous vehicles. The method includes initiating the simulation of the simulated autonomous vehicle within the simulation environment, and providing the simulated autonomous vehicle access to one or more services of the one or more backend systems of the service entity during the simulation.

### PRIORITY CLAIM

The present application is based on and claims the benefit of U.S. Provisional Application No. 62/790,827 having a filing date of Jan. 10, 2019 and U.S. Provisional Application No. 62/797,040 having a filing date of Jan. 25, 2019, both of which are incorporated by reference herein in their entirety for all purposes.

### FIELD

The present disclosure relates generally to evaluating computing systems associated with autonomous vehicle services.

### BACKGROUND

An autonomous vehicle is a vehicle that is capable of sensing its environment and navigating without human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion path for navigating through such surrounding environment.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method for autonomous vehicle service assignment simulation. The method includes obtaining, by a computing system comprising one or more computing devices, data indicative of an autonomous vehicle to be tested within a simulation associated with a service entity. The method includes generating, by the computing system, a simulation environment for the simulation and generating, by the computing system, an autonomous vehicle (e.g., a simulated autonomous vehicle, a representation of an autonomous vehicle operating in a real world environment (test track), etc.) within the simulation environment based at least in part on the data indicative of the autonomous vehicle. The method includes accessing, by the computing system, one or more backend systems of the service entity via an application programming interface platform having one or more functional calls defined to be accessed by a third-party autonomous vehicle or a managing entity of third-party autonomous vehicles. The method includes initiating, by the computing system, the simulation of the autonomous vehicle within the simulation environment and providing, by the computing system, the autonomous vehicle access to one or more services of the one or more backend systems of the service entity during the simulation.

Another example aspect of the present disclosure is directed to a computing system. The computing system includes one or more processors, and one or more tangible, non-transitory, computer readable media that collectively store instructions that when executed by the one or more processors cause the computing system to perform operations. The operations include generating a simulation environment for a simulation associated with a service entity, generating a simulated user and a simulated autonomous vehicle within the simulation environment, providing the simulated autonomous vehicle with access to one or more backend systems of the service entity via an application programming interface platform, generating a simulated service assignment associated with the simulated user for the simulated autonomous vehicle, and initiating the simulation within the simulation environment, wherein the simulated autonomous vehicle performs the simulated service assignment associated with the simulated user during the simulation and the simulated autonomous vehicle has access to one or more backend systems of the service entity during the simulation.

Another example aspect of the present disclosure is directed to a communication system, including: a vehicle integration platform comprising one or more processors, the vehicle integration platform configured to facilitate message communication among a plurality of autonomous vehicles; a vehicle service test system including one or more interfaces to facilitate autonomous vehicle service simulations within the vehicle integration platform, the vehicle service test system comprising an offboard trip testing system configured to generate a simulation environment for testing a simulated service assignment and a vehicle simulation service configured to provision a simulated autonomous vehicle for testing within the vehicle service test system; and one or more interfaces configured to obtain test scenario data programmatically generated using a plurality of libraries associated with a plurality of programming languages, the test scenario data indicative of parameters to be used within an autonomous vehicle service assignment simulation of the vehicle service test system.

Other example aspects of the present disclosure are directed to systems, methods, vehicles, apparatuses, tangible, non-transitory computer-readable media, and memory devices for autonomous vehicle service assignment simulation.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

These and other features, aspects, and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system for controlling the navigation of a vehicle according to example embodiments of the present disclosure;

FIG. 2 depicts an example entity infrastructure according to example embodiments of the present disclosure;

FIG. 3 depicts an example entity infrastructure according to example embodiments of the present disclosure;

FIG. 4 depicts example graphical user interface views according to example embodiments of the present disclosure;

FIG. 5 depicts a flow diagram of an example method for offboard vehicle service testing according to example embodiments of the present disclosure;

FIG. 6 depicts example units associated with a computing system for performing operations and functions according to example embodiments of the present disclosure;

FIG. 7 depicts example system components according to example embodiments of the present disclosure;

FIG. 8 depicts a flow diagram of an example method for offboard vehicle service testing according to example embodiments of the present disclosure; and

FIG. 9 depicts an example computing system including a vehicle service testing system according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to improved techniques for simulating the end-to-end distribution and performance of a service assignment by an autonomous vehicle via a service entity infrastructure. For instance, an autonomous vehicle can drive, navigate, operate, etc. with minimal and/or no interaction from a human driver to provide a vehicle service. By way of example, an autonomous vehicle can be configured to provide transportation and/or other services, such as transporting a user (e.g., rider, passenger, etc.) from a first location to a second location. The user can request this transportation service with a service entity, which can create a service assignment for an autonomous vehicle. In some implementations, the service entity can utilize its own fleet of autonomous vehicles to perform a service assignment. The service entity can also have an infrastructure that can allow the service entity to assign the service assignment to an autonomous vehicle of another entity's fleet (e.g., “a third-party autonomous vehicle”). Such an infrastructure can include a platform comprising one or more application programming interfaces (APIs) that are configured to allow third-party autonomous vehicles and provider infrastructure endpoints (e.g., system clients that provide backend services, etc.) to communicate. For example, a service entity infrastructure can include an application programming interface platform which can facilitate communication between third-party autonomous vehicles and endpoints to help aid the delivery of the service assignment to the autonomous vehicle, monitor vehicle progress, provide remote assistance, etc. and, ultimately to support the performance of a service assignment by the third-party autonomous vehicles. The application programming interface (API) platform can have one or more functional calls defined to be accessed by a service entity autonomous vehicle, a third-party autonomous vehicle, or a managing entity of third-party autonomous vehicles. In some examples, the API platform is a public API platform. The service entity can also provide a simulated autonomous vehicle (e.g., generated in a simulation environment, etc.) access to one or more services of one or more backend systems of the service entity during a simulation through the API platform.

The systems and methods of the present disclosure provide improved techniques to help ensure that autonomous vehicles (e.g., of the service entity's fleet, of a third-party fleet, etc.) are able to properly receive and complete service assignments (e.g., transporting a user from one location to another) as well as communicate with the infrastructure endpoints (e.g., backend services). To do so, the infrastructure can include an offboard trip testing (OTT) system that is configured to test an autonomous vehicle's ability to utilize the entity's infrastructure. For instance, the OTT system can generate a simulated autonomous vehicle, a representation of an autonomous vehicle operating in a real-world environment such as a test track, and/or the like within a simulation environment (e.g., a sandbox) and can simulate the provision of a simulated service assignment to the autonomous vehicle (e.g., a simulated autonomous vehicle, a representation of an actual autonomous vehicle, etc.) via the infrastructure (e.g., the API platform) and monitor the ability of the autonomous vehicle to complete the simulated service assignment (e.g., to transport a simulated user from one location to another within a simulated geographic area). Additionally, in some implementations, one or more testing libraries can be included that can provide for the programmatic development of test scenario data and that can interface with the OTT system, for example, to allow for large scale simulation of autonomous vehicle services through the OTT system, such as by simulating the end-to-end distribution and performance of a service assignment by an autonomous vehicle via a service entity infrastructure. In this way, the technology of the present disclosure can verify that the backend services of the entity can be utilized by third party autonomous vehicles to complete service assignments, prior to deploying service assignments to such vehicles in the real-world. This can help avoid potential system and vehicle failures/downtime that may arise from a vehicle's inability to properly communicate with the infrastructure of the service entity, or vice versa.

More particularly, a service entity (e.g., service provider, owner, manager, platform) can use one or more vehicles (e.g., ground-based vehicles such as automobiles, trucks, bicycles, scooters, other light electric vehicles, etc.; flight vehicles; and/or the like) to provide a vehicle service such as a transportation service (e.g., rideshare service), a courier service, a delivery service, etc. For example, the service entity (e.g., via its operations computing system) can receive requests for vehicle services (e.g., from a user) and generate service assignments (e.g., indicative of the vehicle service type, origin location, destination location, and/or other parameters) for the vehicle(s) to perform. The vehicle(s) can be autonomous vehicles that include various systems and devices configured to control the operation of the vehicle. For example, an autonomous vehicle can include an onboard vehicle computing system for operating the autonomous vehicle (e.g., located on or within the autonomous vehicle). The vehicle computing system can obtain sensor data from sensor(s) onboard the vehicle (e.g., cameras, LIDAR, RADAR), attempt to comprehend the vehicle's surrounding environment by performing various processing techniques on the sensor data, and generate an appropriate motion plan through the vehicle's surrounding environment. Moreover, an autonomous vehicle can be configured to communicate with one or more computing devices that are remote from the vehicle. For example, the autonomous vehicle can communicate with a remote computing system that can be associated with the entity, such as the entity's operations computing system. The operations computing system can include a plurality of system clients that can help the service entity monitor, communicate with, manage, etc. autonomous vehicles. In this way, the service entity can manage the autonomous vehicles to provide the vehicle services of the entity.

The autonomous vehicles utilized by the service entity to provide the vehicle service can be associated with a fleet of that service entity or a third-party. For example, the service entity may own, lease, etc. a fleet of autonomous vehicles that can be managed by the service entity (e.g., via system clients) to provide one or more vehicle services. In some implementations, an autonomous vehicle can be associated with a third-party entity such as, for example, an individual, an original equipment manufacturer (OEM), or another entity (e.g., a “third-party autonomous vehicle”). Even though such an autonomous vehicle may not be included in the fleet of autonomous vehicles of the service entity, the platforms of the present disclosure can allow such a third-party autonomous vehicle to still be utilized to provide the vehicles services offered by the service entity, access the service entity system clients, etc.

A service entity infrastructure (e.g., of the entity's operations computing system) can include a public API platform and a private API platform to facilitate services between the service entity infrastructure and autonomous vehicles. The public and/or private API platform can include one or more functional calls defined to be accessed by a service entity autonomous vehicle, a third-party autonomous vehicle, and/or a managing entity of third-party autonomous vehicles. For example, the public API platform can facilitate access to back-end services (e.g., provided by backend system clients of the service entity) by autonomous vehicles associated with one or more third-party vendors (and/or the service entity's own fleet). The public API platform can provide access to services such as service assignment services, routing services, supply positioning services, payment services, remote assist services, and/or the like. The private API platform can provide access to services that are specific to the service entity's autonomous vehicle fleet such as fleet management services, autonomy assistance services, and/or the like. Both the public API platform and the private API platform can each include a gateway API to facilitate communication from the autonomous vehicles to the provider backend infrastructure services (e.g., backend system clients, etc.) and a vehicle API to facilitate communication from the provider backend infrastructure services to the autonomous vehicles. Each of the platform's APIs can have separate responsibilities, monitoring, alerting, tracing, service level agreements (SLAs), and/or the like.

According to aspects of the present disclosure, the service entity's infrastructure can include an offboard trip testing (OTT) system that can help verify that autonomous vehicles (e.g., third-party autonomous vehicles, etc.) are able to fully utilize the backend services (e.g., system clients) of the service entity infrastructure as well as to complete service assignments of the service entity. The OTT system can be configured to simulate the end-to-end distribution, performance, and completion of a service assignment by an autonomous vehicle via the service entity's infrastructure. For example, as further described herein, the OTT system can create a simulated service assignment (e.g., to transport a simulated user), assign the simulated service assignment to an autonomous vehicle (e.g., representative of the third-party autonomous vehicle, etc.), and monitor the performance of the autonomous vehicle. The autonomous vehicle (e.g., simulated autonomous vehicle, etc.) can be provided access to the backend services of the entity's infrastructure while completing the service assignment within a simulated geographic area. Moreover, the OTT system can provide a graphical user interface that allows a human user (e.g., developer, etc.) to study the performance of the autonomous vehicle (e.g., simulated autonomous vehicle, etc.).

The OTT system can include various sub-systems that allow the OTT system to run test simulations and present the results of the simulation. For instance, the OTT system can include a command line interface, a graphical user interface, and an OTT library. The command line interface can be configured to manage test accounts (e.g., third party/vendor accounts, vehicle accounts, simulated user accounts, driver accounts, etc.). For example, the command line interface can be configured to create, delete, inspect, etc. data fields for test simulations/accounts to be utilized for simulation testing. The command line interface can also be configured to help facilitate the download of other tools, IDLs, libraries, etc. The OTT system can also include a graphical user interface (e.g., a web interface, etc.) that allows a human user (e.g., developer, etc.) to create simulated service assignments, visualize simulated service assignments and/or other information (e.g., logs, metrics, etc.), mock simulated user (e.g., rider, etc.) behavior, etc. The OTT system can also include a library that allows for the programmatic performance of the functions of the command line interface and the graphical user interface. One or more of these sub-systems can be accessed outside of a network of the service entity. For example, a computing system of a third-party entity (e.g., third-party vendor) can access and allow a human user (e.g., developer, etc.) to utilize the graphical user interface of the OTT system. In another example, a developer may utilize one or more libraries incorporated into code to access and programmatically implement simulations by the OTT. Accordingly, the OTT can provide a set of libraries for various programming languages (e.g., Python, Java, Go, etc.). Each set of libraries can be configured for a particular programming language to allow developer-written instructions to be written that directly interface with the OTT system. The OTT system can include one or more interfaces configured to obtain test scenario data that is generated programmatically by code incorporating these libraries. Additionally, the OTT system can provide simulation result data back to a system that receives the simulation result data programmatically through one or more libraries.

The OTT system can include a dedicated OTT API and an OTT backend system client. The OTT API can facilitate communication with the OTT system by another computing system. The OTT backend system can include a plurality of endpoints (e.g., system clients, etc.) that provide services for running the simulations. For instance, the OTT backend system can include a user service that manages test user accounts (e.g., for simulated riders, etc.) and allows for the simulation of user application behavior (e.g., associated with a mobile app downloaded to a user device). Additionally, or alternatively, the OTT backend system can include a vehicle service that manages test vehicle accounts (e.g., for simulated autonomous vehicles) and that obtains data indicative of simulated vehicle state. The user service and the vehicle service can host the logic for simulated service assignments and can delegate managing the state of the service assignment to a production infrastructure (e.g., an itinerary service).

The OTT backend system can include one or more other services. For instance, the OTT system can include a simulation environment service that manages simulation environments. For example, the simulation environment service can be or otherwise include a sandbox service (e.g., simulation environment service) that manages sandboxes (e.g., simulation environments). A sandbox can include an environment (e.g., a sandbox for simulating autonomous vehicle performance, etc.) that isolates tests and simulations from a production environment (e.g., real-world service assignment allocation systems and vehicle monitoring). The simulation environments (e.g., sandboxes, etc.) can provide a mechanism to override certain parameters of the service entity's infrastructure and/or configure specific marketplace conditions which may not be available for normal production trips (e.g., real-world service assignments). By way of example, a simulation environment can allow for the enforcement of the service assignment matching service to match a simulated user service request with a particular set of simulated autonomous vehicles (and/or simulated drivers). In another example, the simulation environment (e.g., sandbox, etc.) can allow for the assignment of a specific user assist operator to a specific simulated autonomous vehicle. Thus, a simulation environment can be a logical container for simulated service assignments, marketplace configuration overrides, simulated actors, etc.

When configuring a simulation, a third-party entity (e.g., a computing system associated therewith) can request a simulation environment, configure it with a set of actors (e.g., simulated user(s), simulated autonomous vehicle(s), representation(s) of actual autonomous vehicle(s), simulated driver, etc.), run simulations, and deactivate the simulation environment after the simulation run is completed. In some implementations, an actor can be used only in one simulation environment at any given time to provide isolation between simulation runs. In some implementations, simulation environments (e.g., sandboxes, etc.) can be used for capturing test logs, actor state changes (e.g., which can be replayed or reproduced), and/or other information. The simulation environment service can use an external database for persisting data (e.g., sandbox data, etc.) and actor registry. Such data can include, for example, static entries such as registry of actors and their keys in other systems and information about which actors belong within which sandbox. In some examples, a third-party entity may integrate one or more libraries into a set of instructions (e.g., program code) that can programmatically interface with the OTT system to request a simulation environment, configure it with a set of actors (e.g., simulated user(s), simulated autonomous vehicle(s), simulated driver, etc.), run simulations, and/or deactivate the simulation environment after the simulation run is completed.

According to another aspect of the present disclosure, the service entity's infrastructure can provide for one or more testing libraries that allow for the programmatic development of test scenario data to facilitate simulations through the OTT system. A testing library provides an interface to the OTT system to run simulations based on the test scenarios. The testing library can provide abstractions of a service entity's infrastructure endpoints that allow a developer to develop autonomous vehicle testing scenarios that provide for running simulations on a large scale and/or frequent basis. For example, a developer can create testing library scenarios that will simulate service assignment flows and assert expected assignment results and/or autonomous vehicle behavior. The test library interacts with the OTT system to provide data in a form expected by the OTT system to run simulations based on the testing scenarios. As an example, a testing library can provide for developing scenarios to quickly implement simulations for different autonomous vehicle types (e.g., different capabilities, different constraints, etc.), different operating domains (e.g., cities, neighborhoods, regions, etc.), and/or the like. The testing library can allow for using scenarios at a larger scale, for example, allowing for running a large number of simulations using the same scenarios.

In accordance with aspects of the present disclosure, testing libraries can be provided for various programming languages (e.g., Python, Go, Java, etc.). Each set of testing libraries can be configured for a particular programming language (e.g., Python, Go, Java, etc.) to allow developer-written instructions to be written that directly interface with the OTT system. The OTT system can include one or more interfaces configured to obtain test scenario data that is generated programmatically by code incorporating these testing libraries. Additionally, the OTT system can provide simulation result data back to a system that receives the simulation result data programmatically through one or more testing libraries. In some embodiments, systems can allow for test scenario data to be programmatically generated and provided to the OTT system using a first testing library written for a first programming language (e.g., Go, Java, Python, etc.) and using a second test library written for a second programming language (e.g., Python, Go, Java, etc.).

According to some example aspects, in some embodiments, a testing library can be a thin layer wrapping the OTT and, optionally, cloud-deployed software development kit (SDK) security middleware. Such a testing library can simplify the use of OTT in language specific test runners. As an example, a testing library scenario can simulate a vehicle service assignment flow and assert expected results (e.g., service completed, etc.) and/or behavior (e.g., vehicle correctly uploaded its state and performed service, etc.).

The following describes an end-to-end example of the functions performed by the OTT system for vehicle simulations. The OTT system can obtain data indicative of an autonomous vehicle to be tested in a simulation environment of a service entity. For example, the OTT system can provision data indicative of a test third-party account (e.g., an account of a third-party entity that is testing its vehicle), data indicative of a simulated vehicle account, etc. (e.g., via the command line interface). The OTT system can also obtain data that is indicative of the capabilities of an autonomous vehicle to be simulated within a simulation run. In some implementations, such data can be included in the vehicle account. The OTT system can also obtain data indicative of a simulated user account (e.g., a test rider, etc.) via the command line interface. The OTT system can start the vehicle simulator and connect it to the public vehicle integration platform (e.g., outside of the executed test) using credentials obtained via the test third-party account, vehicle account, etc. In some implementations, the credentials can be provided when the third-party entity (e.g., a human user or computing system associated therewith) logs-in to access the OTT system. The OTT system can access one or more backend systems of the service entity via the public API platform.

The OTT system can generate (e.g., create, obtain, request, etc.) a simulation environment for the simulation. As described herein, the simulation environment (e.g., sandbox, etc.) can be configured to isolate the simulation from real-world service assignment allocation by the entity's infrastructure and can include the simulated actors (e.g., simulated user, simulated vehicle, etc.) to be utilized in the simulation. In some implementations, the third-party entity (e.g., a human user or computing system associated therewith) can create or open an existing sandbox and configure a simulation within the simulation environment (e.g., via the graphic user interface). For example, this graphical user interface can allow the third-party entity to add actors to a simulation within the simulation environment (e.g., simulated users/accounts, simulated vehicles/accounts, simulated remote operators/accounts, etc.), run a simulation, and/or visualize a simulation, as further described below.

The OTT system can initiate a simulation of the autonomous vehicle within the simulation environment (e.g., sandbox, etc.). The OTT system can provide the simulated autonomous vehicle access to one or more services of the one or more backend systems of the service entity during the simulation. Such simulation can be configured based on user input (via the graphical user interface) or programmatically. For example, the OTT system can determine a simulated service assignment for the autonomous vehicle to perform within a simulated geographic area. By way of example, the OTT system can generate (e.g., within a sandbox) a simulated user (e.g., rider, etc.) for transportation by the simulated autonomous vehicle. The simulated user can set its origin location within the simulated geographic area. The OTT system can generate a simulated autonomous vehicle based at least in part on the data indicative of the autonomous vehicle. The OTT system can verify that the simulated vehicle reports its position in an expected location and a status of the simulated autonomous vehicle (e.g., that the simulated autonomous vehicle is online and available for a service assignment, etc.). The simulated user can request a vehicle service via a simulated service request and the OTT system can obtain data indicative of the simulated service request associated with the simulated user and the simulated service request can be accepted. The simulated service request can include, for example, an origin location of the simulated user and a destination location of the simulated user within the simulated geographic area. The OTT system can generate a simulated service assignment based at least in part on the simulated service request associated with the simulated user. The simulated service assignment can be, for example, an assignment to transport the simulated user from the origin location to the destination. An itinerary can be created for the simulated autonomous vehicle to perform the simulated service assignment.

The OTT system can assign the simulated service assignment to the simulated autonomous vehicle. In some implementations, the OTT system can verify that the simulated autonomous vehicle can perform the simulated service assignment by, for example, verifying that the simulated autonomous vehicle has an itinerary associated with the simulated user (e.g., by matching an identifier). As the simulated autonomous vehicle navigates to the simulated user, the OTT system can monitor the performance of the simulated service assignment by the simulated autonomous vehicle. For example, the OTT system can determine that the simulated autonomous vehicle is travelling to the origin location of the simulated user, that the simulated autonomous vehicle has arrived at the origin location of the simulated user (e.g., within a certain time), that the simulated autonomous vehicle has arrived at the destination location of the simulated user (e.g., within a certain time), etc. Additionally, or alternatively, the OTT system can identify intermediate states (e.g., of the itinerary, the simulated autonomous vehicle, etc.) during the simulation of the vehicle service. During the performance of the simulated service assignment, the simulated autonomous vehicle may have access to the one or more services of the one or more backend systems of the service entity (e.g., routing, etc.). This can allow the simulation to test the communications between the simulated autonomous vehicle and the backend services of the entity's infrastructure. After the simulation is complete (e.g., the autonomous vehicle arrives at the destination location, etc.), the vehicle can be disconnected from the public API platform and deactivate the simulation environment (e.g., sandbox) associated with the simulation.

The OTT system can provide data indicative of the simulation for display via a user interface of a display device. For instance, the OTT system can provide data indicative of the simulation environment (e.g., sandbox, etc.), the simulated autonomous vehicle, the simulated user (e.g., rider, etc.), the simulated geographic area, etc. for display via the OTT graphical user interface. The graphical user interface can present a representation of the simulated autonomous vehicle for a human user (e.g., developer, etc.) to view. The graphic user interface can display the progress of the simulated autonomous vehicle in real-time as the simulated autonomous vehicle performs the vehicle service of the service assignment. Additionally, or alternatively, the graphical user interface can present log data, state data, timing data (e.g., user pick-up time, drop-off time, etc.), and/or other performance data associated with the simulation (e.g., for viewing by a human user). In this way, the third-party entity that is utilizing the OTT system can evaluate the performance of its autonomous vehicle (and its associated autonomy system) as the simulated autonomous vehicle communicates with the backend services of the entity's infrastructure and undertakes a service assignment.

In accordance with some aspects of the present disclosure, testing libraries can allow for a developer to integrate the testing libraries into computer code to programmatically interface with an integration platform (e.g., service entity public platform). For example, testing libraries can provide for accessing and/or controlling simulation functions (e.g., interfacing with OTT system, etc.), such as: provisioning test developer account(s), test vehicle account(s), and test rider account(s); creating or requesting a simulation environment (e.g., test sandbox) for given set of test actors (e.g., rider and vehicle); instructing test rider to set its location; verifying that vehicle reports its position in expected place and autonomous vehicle status is online and available; instructing test rider to request a pickup; verifying that test vehicle has an itinerary associated with rider's service identifier; verifying that vehicle has arrived at pickup location within certain timeout; asserting one or more intermediate states of the itinerary and/or vehicle; verifying that service is completed; disconnect the vehicle from the public platform and deactivating the simulation environment (e.g., sandbox); and/or the like.

According to another aspect of the present disclosure, a vehicle service test system in accordance with the disclosed technology can provide for improved evaluation of autonomous vehicle services using simulated autonomous vehicles. The test system can enable simulation of an autonomous vehicle as part of a vehicle service within a simulation environment including a geographic area. Various systems and devices configured to control the operation of the vehicle can be simulated. For example, an autonomous vehicle can include an onboard vehicle computing system (e.g., located on or within the autonomous vehicle) that is configured to operate the autonomous vehicle. The vehicle computing system can obtain sensor data from sensor(s) onboard the vehicle (e.g., cameras, LIDAR, RADAR, etc.), attempt to comprehend the vehicle's surrounding environment by performing various processing techniques on the sensor data, and generate an appropriate motion plan through the vehicle's surrounding environment. Moreover, an autonomous vehicle can include a communications system that can allow the vehicle to communicate with a computing system that is remote from the vehicle such as, for example, that of a service entity.

A simulated autonomous vehicle may include a simulation of any portion or all of an autonomous vehicle. For example, an autonomy software stack of an autonomous vehicle or other computer-based systems of the autonomous vehicle can be simulated. One or more instances of a simulated autonomous vehicle can be provisioned and deployed at one or more computing devices. Data including one or more parameters associated with a vehicle service simulation can be obtained. A software developer can provide control commands and/or predefined simulation scenarios for the instance of the autonomous vehicle. Each of the one or more predefined simulation scenarios can be provided as a respective scenario object to the at least one instance of the simulated autonomous vehicle in example embodiments. One or more vehicle service simulations can be performed using the instance of the simulated autonomous vehicle and the one or more parameters. Data indicative of the vehicle service simulations can be generated and/or stored by the vehicle service test system. In this manner, a vehicle service-flow and/or autonomous vehicle can be quickly evaluated and debugged prior to actual deployment of an autonomous vehicle in association with the vehicle service. In some examples, data can be exchanged using one or more testing libraries.

The vehicle service test system can obtain data defining at least one instance of a simulated autonomous vehicle. In some examples, a user such as a developer may define the at least one instance of the simulated autonomous vehicle using one or more interfaces provided by the vehicle service test system. In this manner, a user may provision a new simulated autonomous vehicle to be evaluated in accordance with one or more vehicle services. The data defining the at least one instance of the simulated autonomous vehicle may include data defining one or more capabilities of the autonomous vehicle, a state of the autonomous vehicle, etc. In some examples, a user may provision a simulated autonomous vehicle using one or more testing libraries.

The instance(s) of the simulated autonomous vehicle can be deployed as a network service in some examples, such as at one or more servers in direct communication with the vehicle service test system. In other examples, the instances of the simulated autonomous vehicle can be deployed at a local computing device remote from the vehicle service test system. The local computing device can be operated by the same entity that operates an autonomous vehicle service platform, or by a third-party entity. In either case, the vehicle service test system can communicate with the simulated autonomous vehicle instances using various communication protocols. In some examples, each instance of a simulated autonomous vehicle may include an interface such as an interface programmed in a software development kit (SDK) that is similar to or the same as an interface (e.g., SDK) included within an actual autonomous vehicle used to provide the vehicle service. The interface may enable the vehicle service test system to issue instructions to the autonomous vehicle instance to accept a service request, reject a service request, update the pose field of the autonomous vehicle instance, etc. In some examples, a user (e.g., developer, etc.) may deploy instances of a simulated autonomous vehicle using one or more test libraries.

The vehicle service test system can obtain data indicative of one or more parameters for at least one vehicle service simulation. The parameters for a vehicle service simulation may include parameters that define a vehicle service-flow. For example, data defining a vehicle service-flow may define a dispatch of a vehicle service to an instance of a simulated autonomous vehicle. Data defining the vehicle service-flow may also include data instructing the instance of the simulated autonomous vehicle to accept or reject the service request. The data may additionally include data indicative of service-flow updates and/or location updates. The data may indicate a route from a pick-up location to a drop-off location in example embodiments. In some examples, the system may obtain data indicative of one or more parameters for at least one vehicle service simulation using one or more testing libraries.

The vehicle service test system can obtain data for controlling a state of the instance of the simulated autonomous vehicle. The data for controlling the state of the simulated autonomous vehicle instance may enable a user (e.g., developer, etc.) to define or control the autonomous vehicle state. The autonomous vehicle state may be controlled directly, such as by issuing commands to the instance of the autonomous vehicle, or may be controlled using one or more predefined simulation scenarios. In various examples, data indicative of a vehicle state may indicate a position of the simulated autonomous vehicle, credentials for the autonomous vehicle, an autonomous vehicle status, or a client at the vehicle service test system that is associated with the instance of the simulated autonomous vehicle. In some examples, the system can obtain data for controlling a state of the instance of the simulated autonomous vehicle using one or more testing libraries.

The vehicle service test system can perform one or more autonomous vehicle (AV) service simulations using an instance of the simulated autonomous vehicle. An AV service simulation can include parameters that define a step (also referred to as a tick) duration, a vehicle movement strategy (e.g., no operation, move to pickup and drop-off locations, move using a constant speed and straight line, or move using a constant number of steps, etc.), vehicle callbacks (e.g., always reject, always accept, no operation, etc.), and/or a maximum number of steps. A vehicle service simulation can result in a termination condition in response to a vehicle entering a terminal state (e.g., vehicle is offline), a vehicle performing a terminating transition (e.g., door open), a termination command being executed, or a maximum number of steps being reached.

In accordance with some aspects of the disclosed technology, the vehicle service test system may determine and store metrics for a simulated autonomous vehicle session. Example metrics may include for interface calls (e.g., programmed in an SDK): a number of succeeded method attempts; a number of failed method attempts; a latency of attempts; and/or a number of bytes in and out. Example metrics for the session may further include a vehicle state heartbeat; a state using a 1/0 gauge; an exceptions or equivalent (e.g., exception tag); all exceptions; and vehicle uptime.

In accordance with some aspects of the disclosed technology, the vehicle service test system may determine and store metrics for a simulated autonomous vehicle service. Example metrics may include: CPU; memory; GC; number of containers; number of threads; uptime; and/or a number of sessions. Metrics for interface calls (e.g., remote procedure calls) may include: a number of succeeded method attempts; a number of failed method attempts; a latency of attempts; and/or a number of bytes in and out.

In some examples, the vehicle service test system may determine and store success metrics including, by way of example: a time to set up a simulated AV instance and dispatch a trip from the service-flow simulator; a time to provision a simulated AV instance locally or in the platform (e.g., cloud-based) and to go online; a number active platform simulated AVs and sessions per week; a number of platform test services per week; a number of finished scenario jobs per week; a number of scenarios; and/or a number of other projects using the simulated AV instances.

According to some example aspects, a vehicle service test system is provided for an autonomous vehicle service platform. The autonomous vehicle service platform includes a service-flow simulator configured as a tool for simulating service-flows using an autonomous vehicle. The vehicle service test system can include one or more vehicle simulation services. A vehicle simulation service can include one or more instances of a simulated autonomous vehicle. A vehicle simulation service can be provided at the autonomous vehicle service platform as a platform vehicle simulation service in some examples. Additionally and/or alternatively, a vehicle simulation service can be implemented at a computing device remote from the autonomous vehicle service platform as a local vehicle simulation service for example. The vehicle service test system can include one or more testing libraries that can interface with the vehicle service test system to provide for programmatically developing testing scenarios for running autonomous vehicle service simulations. A testing library can be used to interface with one or more simulation services (e.g., OTT system, service-flow simulator, etc.) and/or interface directly with an integration platform.

In some implementations, an autonomous vehicle service platform can include an integration platform configured to integrate autonomous vehicles (e.g., autonomous computing systems) with the autonomous vehicle service platform. In some examples, the integration platform is configured to integrate autonomous vehicles from different systems, such as from different vendors or providers of autonomous vehicles. The integration platform enables multiple third-party systems to be integrated into a single autonomous vehicle service platform. Additionally, the integration platform enables autonomous vehicles directly controlled by the operator of the autonomous vehicle service platform to be integrated into a common service with autonomous vehicles from third-party systems.

A real-time interface can be provided between the integration platform and the service-flow simulator. A service request can be provided from the service-flow simulator through the real-time interface to the integration platform. The autonomous vehicle service platform can include a service-flow updater that passes service-flow updates to and from the integration platform. Service-flow updates can be received at the integration platform as a push notification from the updater. An update can be passed to the instance of the simulated autonomous vehicle corresponding to the service request. For example, an interface (e.g., SDK) inside the autonomous vehicle instance can establish a consistent connection (e.g., HTTP2) with the integration platform. A service request can be matched with the instance of the autonomous vehicle using a flag or other suitable identifier. In some examples, service requests can be programmatically simulated via one or more testing libraries.

The instance of the autonomous vehicle connected to the integration platform can be controlled in various manners to facilitate simulation of an autonomous vehicle. For example, a developer can control an instance of the autonomous vehicle directly using commands (e.g., control line interface commands or browser-based interface commands) in some examples. In other examples, a developer can run a predefined simulation scenario to simulate an autonomous vehicle service using the instance of the autonomous vehicle. In some examples, a developer can incorporate one or more testing libraries into code so programmatically control a test autonomous vehicle and/or vehicle service.

In some examples, a vehicle simulation service can be implemented remotely from the autonomous vehicle service platform as a local vehicle simulation service. A developer can dispatch a vehicle service to a locally running instance of a simulated autonomous vehicle. For example, the developer can utilize an interface to the service-flow simulator to initiate a vehicle service request. The developer can also start the local vehicle simulation service using an interface such as a command line interface (CLI) tool. In some examples, a self-signed autonomous vehicle certificate and credentials obtained from an accounts tool can be used. The interface inside the local vehicle simulation service can establish a consistent connection with the integration platform and perform authentication. After the local vehicle simulation service is connected to the integration platform, a developer can access the service-flow simulator through an interface using the same test credentials to make a vehicle service request. In some examples, this can be done using a real-time application programming interface (API) client. The vehicle service request can be matched with the instance of the simulated autonomous vehicle using a tag or other identifier. The integration platform can receive a push notification from the service flow updater and forward it to the interface of the autonomous vehicle instance running inside the local vehicle simulation service. The developer can control the autonomous vehicle instance using commands or by running a predefined simulation scenario to simulate a vehicle service. In some examples, the local vehicle simulation service can be configured to save logs in a file and/or send them to a remote service. One or more testing libraries may be used to interface with the autonomous vehicle service platform.

In some examples, a vehicle simulation service can be implemented at the autonomous vehicle service platform, such as at the same set of servers and/or within the same network used to implement the autonomous vehicle service. Such a platform vehicle simulation service can include one or more instances of a simulated autonomous vehicle. Each instance of the simulated autonomous vehicle can include an interface (e.g., SDK) associated with the integration platform. A developer can provide data in association with the instance of the autonomous vehicle and data in association with the vehicle service simulation through the same interface. For example, a developer can access an interface for the simulator to initialize and/or modify a state of the simulated autonomous vehicle instance. Additionally, the same interface may be used to dispatch, accept, and simulate a vehicle service using the autonomous vehicle instance. In this manner, a developer can use a graphical user interface such as a browser interface rather than a command line interface for controlling an autonomous vehicle instance. The simulator may include a vehicle simulation service client configured to communicate with the platform vehicle simulation service. For example, the vehicle simulation service client can communicate with the platform vehicle simulation service to accept vehicle service requests and control the autonomous vehicle instance. The state of the autonomous vehicle instance can be stored and updated in the simulator interface, and pushed to the platform vehicle simulation service. The platform vehicle simulation service can be stateful and can route calls to the autonomous vehicle instance where the requested autonomous vehicle interface is running. One or more testing libraries may be used to interface with the autonomous vehicle service platform.

In accordance with example aspects, a vehicle simulation service may include a session which is a stable, long-running task used to simulate a vehicle service-flow of an autonomous vehicle. In such examples, one instance of the vehicle simulation service session can be used to model one instance of the autonomous vehicle. For example, there can be one instance of the same simulated autonomous vehicle session within the autonomous vehicle service platform at a given time. In this manner, two sessions of an autonomous vehicle instance can be the same if they start using the same simulated autonomous vehicle identifier.

A simulated autonomous vehicle instance can include a session simulator and an integration platform interface in some examples. The integration platform interface can be a software development kit in some embodiments. The session simulator can include a state component and a controller. The state of a simulated autonomous vehicle instance session can be compact and simple. For example, the state of an AV instance session can include attributes such as a position of the autonomous vehicle, credentials for the autonomous vehicle, a status of the autonomous vehicle, and/or an identification of the vehicle simulation service client interface at the service-flow simulator. In some examples, the state can be persisted in an external and/or internal system. This may allow restoring sessions after service upgrades and restarts. The session controller can be used to access and modify the session state. The session simulator can provide callbacks to the integration platform interface and can define behavior of the simulated autonomous vehicle by connecting the integration platform interface with the session state. For example, the session simulator can define callbacks giving vehicle position from the session state to the integration platform interface. The session simulator can also be used to execute simulation scenarios. Locally, a developer can link a vehicle simulation service to a custom location of an integration platform interface repository for debugging. With the vehicle simulation services implemented at the platform, a mechanism and remote procedure call can be exposed for setting a custom version of the integration platform interface for each session individually to provide improved flexibility.

In some examples, a vehicle simulation service process may communicate with the integration platform and simulation interfaces such as the service-flow simulator interface and/or vehicle simulator interface. In some examples, interfaces may be provided at one or more client computing devices. The vehicle simulation service process may include one or more endpoints (e.g., remote procedure call (RPC) end points) to facilitate communication with simulation interfaces (e.g., client computing devices using CLI and/or RPC). For example, the vehicle simulation service process can route remote procedure calls to simulated autonomous vehicle session controllers using client RPC credentials. Optionally, the vehicle simulation service process can include an interface tool which can simplify calling RPC endpoints from a terminal. The one or more endpoints may receive and/or transmit credentials, simulation scenarios, and/or control commands to and from the simulation interfaces. The vehicle simulation service process may additionally include an integration component and configuration injector. The vehicle simulation service process may include one or more vehicle sessions. The vehicle simulation service process may receive one or more default credentials and/or default simulation scenarios from a configuration/environment. The vehicle simulation service process may send and receive service-flow updates to and from the integration platform. Additionally, the vehicle simulation service process may provide location updates of the simulated autonomous vehicle to the integration platform. Various logs and metrics associated with a vehicle simulation can be provided from the vehicle simulation service process to a logging/metrics interface. Optionally, the vehicle simulation service process can provide data indicative of a simulated autonomous vehicle session state and/or synchronization information to a storage device or service. In some examples, a vehicle simulation service can optionally allow the use of an external storage service for persisting and restoring vehicle sessions. The external storage can also be used to implement synchronization for simulated autonomous vehicle sessions such as in a sharding mechanism. The various components can be accessed via one or more testing libraries.

In accordance with example embodiments, a simulated autonomous vehicle instance may utilize one or more application programming interfaces (APIs). For example, a first call may allow provisioning of an autonomous vehicle. The first call may cause the generation of a self-signed certificate and the creation of a new instance of an autonomous vehicle. An error may be returned if there is already an existing instance of the vehicle created with the same universal identifier. A second call may cause deletion of a vehicle instance from the vehicle simulation service. An error can be returned of the vehicle does not exist or cannot be removed. A third call can cause retrieval of information about a given vehicle instance. A fourth call can return information about all vehicle instances provisioned within the vehicle simulation service.

In accordance with example embodiments, a session simulator of a simulated autonomous vehicle instance may utilize one or more APIs. A first call for the session simulator may start a new simulated autonomous vehicle session for a given vehicle. A second call can stop a simulated autonomous vehicle session for a given vehicle. A third call can return the current state of an autonomous vehicle session. A fourth call can attempt to execute a go online function and update the status field of a vehicle state. A fifth call can attempt to execute a client go off-line function and update a status field of the vehicle state. A sixth call can update the pose field of the vehicle state. A seventh call can instruct the session simulator to accept a vehicle service request. An eighth call can instruct the session simulator to reject a vehicle service request. A ninth call can find a stored simulation scenario by universal identifier and execute it. A tenth call can execute a provided simulation scenario object.

According to another aspect of the present disclosure, an autonomous vehicle integration kit can include a set of testing tools, services, and components that can be used by developers (e.g., third-party developers, service entity developers, etc.) to provide integration testing between autonomous vehicles and a service entity's public platform. An autonomous vehicle integration kit can provide for provisioning test entities such as test autonomous vehicles and test rider accounts, creating and simulating test service assignments, validating vehicle state and/or assignment status, provide API explorer and reference implementation of public platform protocol for service assignment, and/or the like. According to example aspects of the present disclosure, an autonomous vehicle integration kit can at least include an OTT system (e.g., command line interface, graphical user interface, etc.), testing libraries, vehicle simulation service, and/or the like, as described herein. In accordance with example aspects, autonomous vehicle integration kit tools can be operated outside of a service entity infrastructure (e.g., by third-party developers, etc.), for example, by communicating with the service entity infrastructure using one or more APIs.

The systems and methods described herein provide a number of technical effects and benefits. More particularly, the systems and methods of the present disclosure provide improved techniques for evaluating the ability of an autonomous vehicle (e.g., of a third-party vehicle fleet) to integrate and communicate with the infrastructure of a service entity. For instance, the OTT system (and its associated processes) allow the service entity and/or a third-party entity (e.g., vehicle vendor) to create test entities such as simulated autonomous vehicles and simulated user accounts and to create simulated service assignments (e.g., for given pickup and drop-off locations) and match them with a simulated autonomous vehicle. The OTT system provides a third-party entity with a debugging mechanism that simulates user (e.g., rider, etc.) behavior and verifies that the service calls from the third-party's autonomous vehicle and/or a backend service progressed the service assignment to the expected state. Additionally, the OTT system allows the service entity and/or a third-party entity to create and visualize simulated autonomous vehicle service assignments (e.g., using a web interface, programmatically, etc.), to verify service assignment status, and monitor an observed state of the simulated autonomous vehicles. Moreover, the OTT system allows for this type of simulation to occur in a simulation environment (e.g., sandbox, etc.) that is isolated from real-world service assignment production, allocation, and coordination. This leads to an improved integration with the service entity's infrastructure (and the public API platform) by making the integration process more straightforward and helping to build more confidence in the platform, without having to distribute a real-world production service assignment to the autonomous vehicle. As such, integration issues can be efficiently identified in an offline, isolated environment before deployment of the vehicles in the real-world.

Additionally, testing libraries can provide the technical effect and benefit of allowing developers to quickly and easily generate computer code integrating the testing libraries to programmatically interface with the OTT system to run autonomous vehicle service simulations. The use of testing libraries provides for more efficient vehicle integration testing. This leads to reduced computational waste and reduces bandwidth requirements by providing a programmatic interface for operating simulations.

Various means can be configured to perform the methods and processes described herein. For example, a computing system can include data obtaining unit(s), simulation environment generation unit(s), actor generation unit(s), simulation unit(s), user interface unit(s), testing library data generation unit(s), and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to obtain data indicative of an autonomous vehicle to be tested within a simulation associated with a service entity (e.g., tester account data, vehicle account data, vehicle autonomy capability data, etc.). The means can be configured to generate a simulation environment (e.g., sandbox) for the simulation. The means can be configured to generate actors for the simulation. For example, the means can be configured to generate a simulated user, a simulated autonomous vehicle, and/or other actor(s) within the simulation environment. The means can access one or more backend systems of the service entity via an application programming interface platform having one or more functional calls defined to be accessed by a third-party autonomous vehicle or a managing entity of third-party autonomous vehicles. The means can initiate the simulation of the simulated autonomous vehicle within the sandbox, as described herein. The means can provide the simulated autonomous vehicle access to one or more services of the one or more backend systems of the service entity during the simulation. The means can be configured to obtain test scenario data indicative of simulation parameters. The means can be configured to generate simulation control data based on test scenario data. The means can be configured to provide simulation control data to run one or more simulations. The means can be configured to obtain and/or generate simulation result data.

With reference to the figures, example embodiments of the present disclosure will be discussed in further detail.

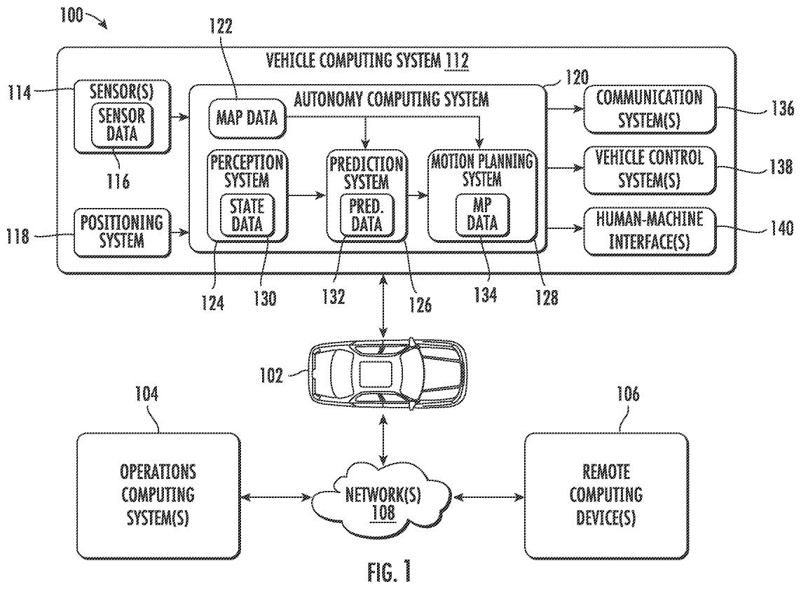

FIG. 1 depicts a block diagram of an example system 100 for controlling the navigation of a vehicle according to example embodiments of the present disclosure. As illustrated, FIG. 1 shows a system 100 that can include a vehicle 102; an operations computing system 104; one or more remote computing devices 106; a communication network 108; a vehicle computing system 112; one or more autonomy system sensors 114; autonomy system sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; and a human-machine interface 140.

The operations computing system 104 can be associated with a service provider (e.g., service entity) that can provide one or more vehicle services to a plurality of users via a fleet of vehicles (e.g., service entity vehicles, third-party vehicles, etc.) that includes, for example, the vehicle 102. The vehicle services can include transportation services (e.g., rideshare services), courier services, delivery services, and/or other types of services.

The operations computing system 104 can include multiple components for performing various operations and functions. For example, the operations computing system 104 can include and/or otherwise be associated with the one or more computing devices that are remote from the vehicle 102. The one or more computing devices of the operations computing system 104 can include one or more processors and one or more memory devices. The one or more memory devices of the operations computing system 104 can store instructions that when executed by the one or more processors cause the one or more processors to perform operations and functions associated with operation of one or more vehicles (e.g., a fleet of vehicles), with the provision of vehicle services, and/or other operations as discussed herein.

For example, the operations computing system 104 can be configured to monitor and communicate with the vehicle 102 and/or its users to coordinate a vehicle service provided by the vehicle 102. To do so, the operations computing system 104 can manage a database that includes data including vehicle status data associated with the status of vehicles including the vehicle 102. The vehicle status data can include a state of a vehicle, a location of a vehicle (e.g., a latitude and longitude of a vehicle), the availability of a vehicle (e.g., whether a vehicle is available to pick-up or drop-off passengers and/or cargo, etc.), and/or the state of objects internal and/or external to a vehicle (e.g., the physical dimensions and/or appearance of objects internal/external to the vehicle).

The operations computing system 104 can communicate with the one or more remote computing devices 106 and/or the vehicle 102 via one or more communications networks including the communications network 108. The communications network 108 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 108 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 102.

Each of the one or more remote computing devices 106 can include one or more processors and one or more memory devices. The one or more memory devices can be used to store instructions that when executed by the one or more processors of the one or more remote computing devise 106 cause the one or more processors to perform operations and/or functions including operations and/or functions associated with the vehicle 102 including exchanging (e.g., sending and/or receiving) data or signals with the vehicle 102, monitoring the state of the vehicle 102, and/or controlling the vehicle 102. The one or more remote computing devices 106 can communicate (e.g., exchange data and/or signals) with one or more devices including the operations computing system 104 and the vehicle 102 via the communications network 108.

The one or more remote computing devices 106 can include one or more computing devices (e.g., a desktop computing device, a laptop computing device, a smart phone, and/or a tablet computing device) that can receive input or instructions from a user or exchange signals or data with an item or other computing device or computing system (e.g., the operations computing system 104). Further, the one or more remote computing devices 106 can be used to determine and/or modify one or more states of the vehicle 102 including a location (e.g., a latitude and longitude), a velocity, acceleration, a trajectory, and/or a path of the vehicle 102 based in part on signals or data exchanged with the vehicle 102. In some implementations, the operations computing system 104 can include the one or more remote computing devices 106.

The vehicle 102 can be a ground-based vehicle (e.g., an automobile, bike, scooter, other light electric vehicle, etc.), an aircraft, and/or another type of vehicle. The vehicle 102 can be an autonomous vehicle that can perform various actions including driving, navigating, and/or operating, with minimal and/or no interaction from a human driver. The autonomous vehicle 102 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 102 can provide driving and navigational operation with minimal and/or no interaction from a human driver present in the vehicle. A semi-autonomous operational mode can be one in which the vehicle 102 can operate with some interaction from a human driver present in the vehicle. Park and/or sleep modes can be used between operational modes while the vehicle 102 performs various actions including waiting to provide a subsequent vehicle service, and/or recharging between operational modes.

An indication, record, and/or other data indicative of the state of the vehicle, the state of one or more passengers of the vehicle, and/or the state of an environment including one or more objects (e.g., the physical dimensions and/or appearance of the one or more objects) can be stored locally in one or more memory devices of the vehicle 102. Additionally, the vehicle 102 can provide data indicative of the state of the vehicle, the state of one or more passengers of the vehicle, and/or the state of an environment to the operations computing system 104, which can store an indication, record, and/or other data indicative of the state of the one or more objects within a predefined distance of the vehicle 102 in one or more memory devices associated with the operations computing system 104 (e.g., remote from the vehicle). Furthermore, the vehicle 102 can provide data indicative of the state of the one or more objects (e.g., physical dimensions and/or appearance of the one or more objects) within a predefined distance of the vehicle 102 to the operations computing system 104, which can store an indication, record, and/or other data indicative of the state of the one or more objects within a predefined distance of the vehicle 102 in one or more memory devices associated with the operations computing system 104 (e.g., remote from the vehicle).

The vehicle 102 can include and/or be associated with the vehicle computing system 112. The vehicle computing system 112 can include one or more computing devices located onboard the vehicle 102. For example, the one or more computing devices of the vehicle computing system 112 can be located on and/or within the vehicle 102. The one or more computing devices of the vehicle computing system 112 can include various components for performing various operations and functions. For instance, the one or more computing devices of the vehicle computing system 112 can include one or more processors and one or more tangible, non-transitory, computer readable media (e.g., memory devices). The one or more tangible, non-transitory, computer readable media can store instructions that when executed by the one or more processors cause the vehicle 102 (e.g., its computing system, one or more processors, and other devices in the vehicle 102) to perform operations and functions, including those described herein.

As depicted in FIG. 1, the vehicle computing system 112 can include the one or more autonomy system sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more autonomy system sensors 114 can be configured to generate and/or store data including the autonomy sensor data 116 associated with one or more objects that are proximate to the vehicle 102 (e.g., within range or a field of view of one or more of the one or more sensors 114). The one or more autonomy system sensors 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The autonomy sensor data 116 can include image data, radar data, LIDAR data, and/or other data acquired by the one or more autonomy system sensors 114. The one or more objects can include, for example, pedestrians, vehicles, bicycles, and/or other objects. The one or more sensors can be located on various parts of the vehicle 102 including a front side, rear side, left side, right side, top, or bottom of the vehicle 102. The autonomy sensor data 116 can be indicative of locations associated with the one or more objects within the surrounding environment of the vehicle 102 at one or more times. For example, autonomy sensor data 116 can be indicative of one or more LIDAR point clouds associated with the one or more objects within the surrounding environment. The one or more autonomy system sensors 114 can provide the autonomy sensor data 116 to the autonomy computing system 120.

In addition to the autonomy sensor data 116, the autonomy computing system 120 can retrieve or otherwise obtain data including the map data 122. The map data 122 can provide detailed information about the surrounding environment of the vehicle 102. For example, the map data 122 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 102. The positioning system 118 can be any device or circuitry for analyzing the position of the vehicle 102. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 102 can be used by various systems of the vehicle computing system 112 and/or provided to one or more remote computing devices (e.g., the operations computing system 104 and/or the remote computing device 106). For example, the map data 122 can provide the vehicle 102 relative positions of the surrounding environment of the vehicle 102. The vehicle 102 can identify its position within the surrounding environment (e.g., across six axes) based at least in part on the data described herein. For example, the vehicle 102 can process the autonomy sensor data 116 (e.g., LIDAR data, camera data) to match it to a map of the surrounding environment to get an understanding of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 102 and determine a motion plan for controlling the motion of the vehicle 102 accordingly. For example, the autonomy computing system 120 can receive the autonomy sensor data 116 from the one or more autonomy system sensors 114, attempt to determine the state of the surrounding environment by performing various processing techniques on the autonomy sensor data 116 (and/or other data), and generate an appropriate motion plan through the surrounding environment. The autonomy computing system 120 can control the one or more vehicle control systems 138 to operate the vehicle 102 according to the motion plan.

The perception system 124 can identify one or more objects that are proximate to the vehicle 102 based on autonomy sensor data 116 received from the autonomy system sensors 114. In particular, in some implementations, the perception system 124 can determine, for each object, state data 130 that describes a current state of such object. As examples, the state data 130 for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle class versus pedestrian class versus bicycle class versus other class); yaw rate; and/or other state information. In some implementations, the perception system 124 can determine state data 130 for each object over a number of iterations. In particular, the perception system 124 can update the state data 130 for each object at each iteration. Thus, the perception system 124 can detect and track objects (e.g., vehicles, bicycles, pedestrians, etc.) that are proximate to the vehicle 102 over time, and thereby produce a presentation of the world around an vehicle 102 along with its state (e.g., a presentation of the objects of interest within a scene at the current time along with the states of the objects).

The prediction system 126 can receive the state data 130 from the perception system 124 and predict one or more future locations and/or moving paths for each object based on such state data. For example, the prediction system 126 can generate prediction data 132 associated with each of the respective one or more objects proximate to the vehicle 102. The prediction data 132 can be indicative of one or more predicted future locations of each respective object. The prediction data 132 can be indicative of a predicted path (e.g., predicted trajectory) of at least one object within the surrounding environment of the vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the vehicle 102 based at least in part on the prediction data 132 (and/or other data). The motion plan data 134 can include vehicle actions with respect to the objects proximate to the vehicle 102 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 102 can perform a certain action (e.g., pass an object) without increasing the potential risk to the vehicle 102 and/or violating any traffic laws (e.g., speed limits, lane boundaries, signage). The motion plan data 134 can include a planned trajectory, velocity, acceleration, and/or other actions of the vehicle 102.

As one example, in some implementations, the motion planning system 128 can determine a cost function for each of one or more candidate motion plans for the autonomous vehicle 102 based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle 102 approaches impact with another object and/or deviates from a preferred pathway (e.g., a predetermined travel route).

Thus, given information about the current locations and/or predicted future locations and/or moving paths of objects, the motion planning system 128 can determine a cost of adhering to a particular candidate pathway. The motion planning system 128 can select or determine a motion plan for the autonomous vehicle 102 based at least in part on the cost function(s). For example, the motion plan that minimizes the cost function can be selected or otherwise determined. The motion planning system 128 then can provide the selected motion plan to a vehicle controller that controls one or more vehicle controls (e.g., actuators or other devices that control gas flow, steering, braking, etc.) to execute the selected motion plan.

The motion planning system 128 can provide the motion plan data 134 with data indicative of the vehicle actions, a planned trajectory, and/or other operating parameters to the vehicle control systems 138 to implement the motion plan data 134 for the vehicle 102. For instance, the vehicle 102 can include a mobility controller configured to translate the motion plan data 134 into instructions. By way of example, the mobility controller can translate a determined motion plan data 134 into instructions for controlling the vehicle 102 including adjusting the steering of the vehicle 102 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the operations computing system 104 and/or one or more other remote computing devices (e.g., the one or more remote computing devices 106) over one or more networks (e.g., via one or more wireless signal connections, etc.). In some implementations, the communications system 136 can allow communication among one or more of the systems on-board the vehicle 102. The communications system 136 can also be configured to enable the autonomous vehicle to communicate with and/or provide and/or receive data and/or signals from a remote computing device 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop, and/or smartphone) can be viewable by a user of the vehicle 102 that is located in the front of the vehicle 102 (e.g., driver's seat, front passenger seat). Additionally, or alternatively, a display device can be viewable by a user of the vehicle 102 that is located in the rear of the vehicle 102 (e.g., a back passenger seat).

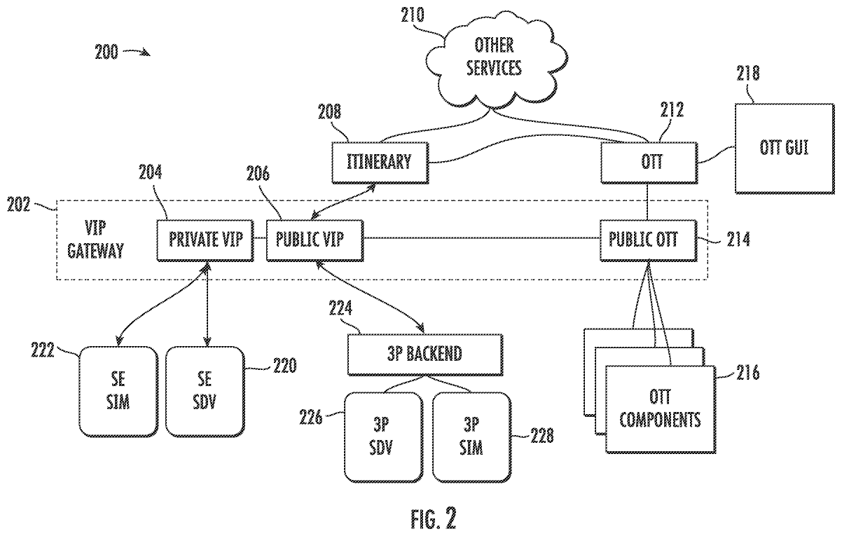

FIG. 2 depicts an example entity infrastructure 200 according to example embodiments of the present disclosure. A service entity (e.g., service provider, owner, manager, platform) can use one or more vehicles (e.g., ground-based vehicles, flight vehicles, etc.) to provide one or more vehicle services such as a transportation service (e.g., rideshare service), a courier service, a delivery service, and/or the like. For example, the service entity (e.g., via its operations computing system) can receive requests for vehicle services (e.g., from a user) and generate service assignments (e.g., indicative of the vehicle service type, origin location, destination location, and/or other parameters) for the vehicle(s) to perform. The vehicle(s) can be autonomous vehicles that include various systems and devices configured to control the operation of the vehicle.

The autonomous vehicles utilized by the service entity to provide the vehicle service can be associated with a fleet of that service entity or a third-party. For example, the service entity may own, lease, etc. a fleet of autonomous vehicles that can be managed by the service entity (e.g., by system clients associated with a service entity system) to provide one or more vehicle services. In some implementations, an autonomous vehicle can be associated with a third-party entity such as, for example, an individual, an original equipment manufacturer (OEM), or another entity (e.g., a “third-party autonomous vehicle”). Even though such an autonomous vehicle may not be included in the fleet of autonomous vehicles of the service entity, the platforms of the present disclosure can allow such a third-party autonomous vehicle to still be utilized to provide the vehicles services offered by the service entity, access its system clients, etc.

The service entity can provide an infrastructure 200 that can allow the service entity to assign the service assignment to an autonomous vehicle of the service entity's fleet, an autonomous vehicle of another entity's fleet (e.g., “a third-party autonomous vehicle”), and/or the like. Such an infrastructure 200 can include a platform (e.g., vendor integration platform (VIP)) comprising one or more application programming interfaces (APIs) that are configured to allow third-party autonomous vehicles (e.g., third-party AV 226) and provider infrastructure endpoints (e.g., system clients that provide backend services, etc. such as itinerary service 208, other services 210, etc.) to communicate. For example, a service entity infrastructure 200 can include an application programming interface platform (e.g., public VIP 206) which can facilitate communication between third-party autonomous vehicles and endpoints to help aid the delivery of a service assignment to the autonomous vehicle, monitor vehicle progress, provide remote assistance, etc. and, ultimately to support the performance of a service assignment by the third-party autonomous vehicles. The application programming interface (API) platform can have one or more functional calls defined to be accessed by a third-party autonomous vehicle (e.g., third-party AV 226) or a managing entity of third-party autonomous vehicles (e.g., third-party backend 224). In some examples, the API platform is a public API platform, such as shown by public VIP 206. The service entity can also provide third-party simulated autonomous vehicle (e.g., third-party sim 228) access to one or more services of one or more backend systems of the service entity during a simulation through the API platform, for example, via a testing system API such as public OTT 214. The service entity can also provide a service entity simulated autonomous vehicle (e.g., service entity sim 222) access to one or more services of one or more backend systems of the service entity during a simulation through the API platform.

The service entity infrastructure 200 can include a public API platform (e.g., public VIP 206) and a private API platform (e.g., private VIP 204) to facilitate services between the service entity infrastructure and autonomous vehicles (e.g., service entity autonomous vehicles 220, third-party autonomous vehicles 226). The public and/or private API platform can include one or more functional calls defined to be accessed by a third-party autonomous vehicle or a managing entity of third-part autonomous vehicles (and/or a service entity autonomous vehicle). For example, the public API platform (e.g., public VIP 206) can facilitate access to back-end services (e.g., provided by service entity backend system clients) by autonomous vehicles associated with one or more third-party vendors and/or the service entity's own fleet. The public VIP 206 can provide access to services such as service assignment services, routing services, supply positioning services, payment services, remote assist services, and/or the like. The private API platform (e.g., private VIP 204) can provide access (e.g., by service entity autonomous vehicles 220) to services that are specific to the service entity's autonomous vehicle fleet such as fleet management services, autonomy assistance services, and/or the like. Both the public VIP 206 and the private VIP 204 can include and/or be associated with a gateway API (e.g., VIP gateway 202) to facilitate communication from the autonomous vehicles to the service entity backend infrastructure services (e.g., backend system clients, etc.) and a vehicle API to facilitate communication from the service entity backend infrastructure services to the autonomous vehicles. Each of the platform's APIs can have separate responsibilities, monitoring, alerting, tracing, service level agreements (SLAs), and/or the like.

The service entity infrastructure 200 can include an OTT system 212 that can help verify that autonomous vehicles (e.g., entity autonomous vehicles, third-party autonomous vehicles, etc.) are able to fully utilize the backend services (e.g., system clients) of the service entity infrastructure 200 as well as to complete service assignments of the service entity. The OTT system 212 can be configured to simulate the end-to-end distribution, performance, and completion of a service assignment by an autonomous vehicle via the service entity infrastructure 200. For example, the OTT 212 system can create a simulated service assignment, assign the simulated service assignment to simulated autonomous vehicle (e.g., entity autonomous vehicle sim 222, third-party autonomous vehicle sim 228), and monitor the performance of the simulated autonomous vehicle. The simulated autonomous vehicle can be provided with access to the backend services of the service entity infrastructure 200 while completing the service assignment within a simulation environment. The service entity infrastructure 200 can include a testing system API, such as public OTT 214 to allow access to one or more services of one or more backend systems of the service entity via one or more OTT tools (e.g., OTT components 216) during a simulation through a API platform gateway (e.g., VIP gateway 202).

The OTT system 212 can include various sub-systems (e.g., OTT components 216, etc.) that allow the OTT system to run test simulations and present the results of the simulation. For instance, the OTT system can include a command line interface, a graphical user interface (e.g., OTT GUI 218), and an OTT library. The command line interface can be configured to manage test accounts (e.g., third party/vendor accounts, vehicle accounts, simulated user accounts, driver accounts, etc.). For example, the command line interface can be configured to create, delete, inspect, etc. data fields for test simulations/accounts to be utilized for simulation testing. The command line interface can also be configured to help facilitate the download of other tools, IDLs, libraries, etc. The OTT system 212 can also include a graphical user interface (e.g., OTT GUI 218) that allows a user to create simulated service assignments, visualize simulated service assignments, vehicles, and/or other information (e.g., logs, metrics, etc.), mock simulated user (e.g., rider, etc.) behavior, etc. The OTT system 212 can also include a library that allows for the programmatic performance of the functions of the command line interface and the graphical user interface. One or more of these sub-systems (e.g., OTT components 216) can be accessed outside of a network of the service entity, for example via public OTT 214.

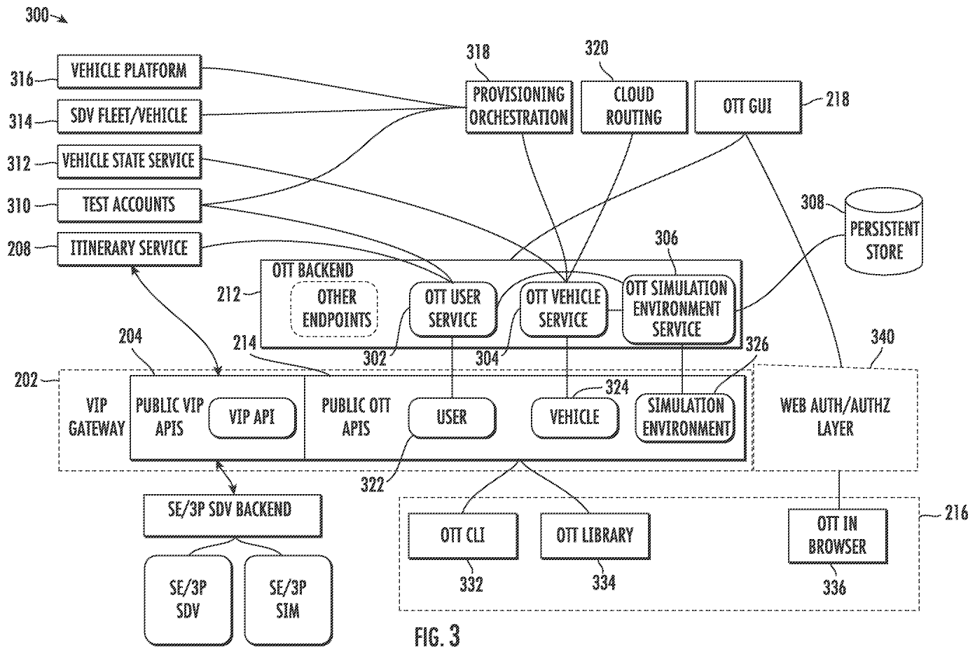

FIG. 3 depicts another example of a service entity infrastructure 300 according to example embodiments of the present disclosure. The service entity infrastructure 300 illustrated in FIG. 3 provides another view of the OTT system within a service entity infrastructure such as described in regard to FIG. 2. Similar to FIG. 2, the service entity infrastructure 300, as illustrated in FIG. 3, includes VIP gateway 202 to facilitate communication from autonomous vehicles to service entity backend infrastructure services (e.g., backend system clients, etc.) and public VIP 204 to facilitate services between the service entity infrastructure and autonomous vehicles. The service entity infrastructure 300 also includes OTT system 212 to facilitate simulation of service assignment performance by an autonomous vehicle and Public OTT 214 to facilitate access to one or more services of the service entity backend systems via one or more OTT components 216 during a simulation.

The OTT backend system 212 can include a plurality of endpoints (e.g., system clients, etc.) that provide services for running the simulations. For example, the OTT system 212 can include an OTT user (e.g., rider) service 302, an OTT vehicle service 304, and an OTT simulation environment (e.g., sandbox) service 306. The OTT user service 302 can provide for managing test user accounts (e.g., via test accounts service 310) and can facilitate simulating user application behavior (e.g., associated with a mobile app downloaded to a user device). The OTT vehicle service 304 can provide for managing test vehicle accounts (e.g., via provisioning orchestration service 318, test accounts service 310, AV fleet/vehicle service 314, vehicle platform service 316, etc.) and can facilitate obtaining data indicative of simulated vehicle state (e.g., via vehicle state service 312). The OTT user service 302 and the OTT vehicle service 304 can host the logic for simulated service assignments and can delegate managing the state of the service assignment to a production infrastructure (e.g., via itinerary service 208). The OTT vehicle service 304 can also provide for obtaining data indicative of vehicle routes and estimated arrival times (e.g., via cloud routing service 320). The public OTT 214 can include public OTT user service 322, public OTT vehicle service 324, and public OTT simulation environment service 326 which can facilitate between the OTT components 216 and the services included within the OTT system 212 (e.g., OTT user service 302, OTT vehicle service 304, OTT simulation environment service 306, etc.).

The OTT simulation environment service 306 can provide for managing simulation environment(s) (e.g., sandboxes) that isolate tests and simulations from a production environment (e.g., real-world service assignment allocation systems and vehicle monitoring systems). The simulation environment(s) can provide a mechanism to override certain parameters of the service entity's infrastructure and/or configure specific marketplace conditions which may not be available under normal production conditions (e.g., real-world service assignments). The OTT simulation environment service 306 can use an external database (e.g., persistent store 308) for persisting simulation environment data (e.g., sandbox data) and/or actor registry data.

The OTT components 216 can facilitate different types of workflows associated with service assignment simulations. For example, the OTT components 216 can include OTT command line interface (CLI) 332, OTT library 334, and OTT browser 336. The OTT CLI 332 can facilitate managing developer accounts and test accounts, managing programming components, managing simulation environments, and/or the like. The OTT CLI 332 can also facilitate simulation testing (e.g., create, delete, inspect, etc. data fields for test simulations/accounts to be utilized for simulation testing). The OTT library 334 can facilitate the programmatic performance of one or more functions of the command line interface and/or the graphical user interface. The OTT browser 336 facilitates access to the OTT GUI 218 and can provide for authentication and/or authorization of third-party entities (e.g., developers, etc.), for example, via a web authentication/authorization layer 340.

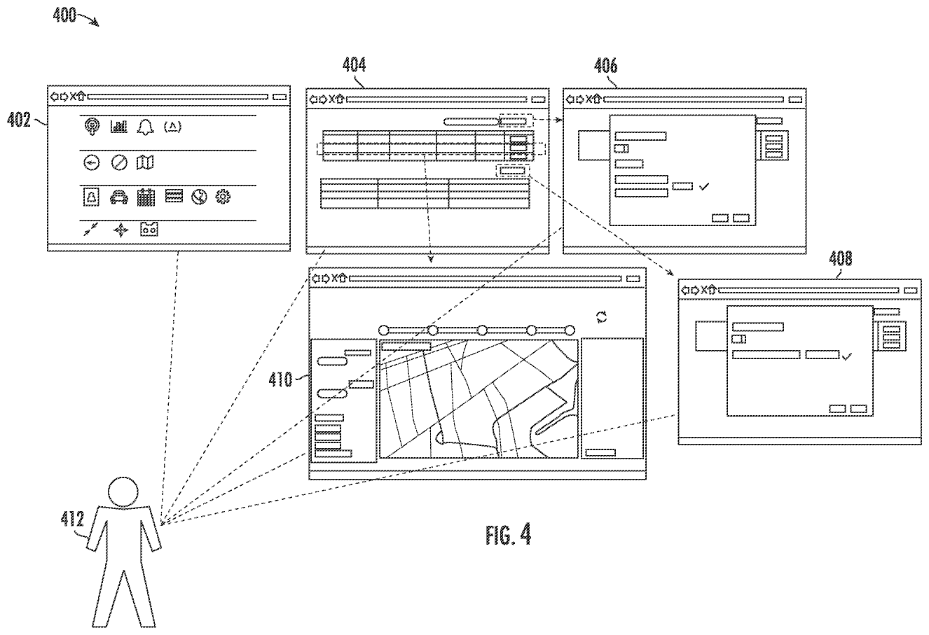

FIG. 4 depicts example graphical user interface 400 views according to example embodiments of the present disclosure. As described herein, an OTT system can help verify that autonomous vehicles (e.g., third-party autonomous vehicles, service entity autonomous vehicles, etc.) are able to fully utilize the backend services (e.g., system clients) of the service entity infrastructure as well as to complete service assignments of the service entity. In some implementations, the OTT system can provide one or more graphical user interfaces (e.g., a web interface, etc., such as illustrated by graphical user interface 400) to assist in the generation and/or monitoring of simulated service assignments for a simulated autonomous vehicle as well as to allow a human user (e.g., developer, etc.) to study the performance of a simulated autonomous vehicle. The graphical user interface 400 can provide for a human user (e.g., developer, etc.) to create simulation environments/vehicles, create simulated service assignments, visualize simulated service assignments and/or other information (e.g., logs, metrics, etc.), mock simulated user (e.g., rider, etc.) behavior, and/or the like through the OTT system.

For example, as illustrated in FIG. 4, a graphical user interface 400 can provide for a user (e.g., developer, etc.) 412 to access various data and/or controls associated with the OTT system, such as shown in GUI screen view 402 and GUI screen view 404. Graphical user interface 400 can provide access to data and/or controls associated with simulation environments (e.g., sandboxes), simulated test vehicles, test accounts, and/or the like, such as illustrated by GUI screen view 404, and provide for the generation of new simulation environments (e.g., GUI screen view 406) and new simulated test vehicles (e.g., GUI screen view 408). Graphical user interface 400 can also provide for visualizing simulated service assignments, simulated autonomous vehicle status, behavior and/or the like, such as illustrated in GUI screen view 410.

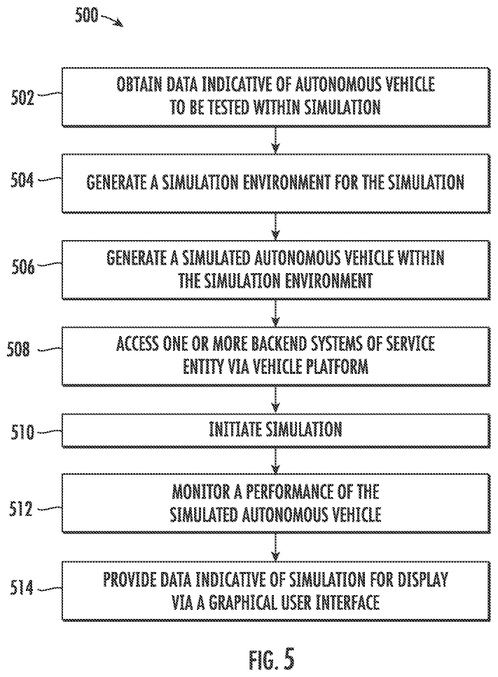

FIG. 5 depicts a flow diagram of an example method 500 for offboard vehicle service testing (e.g., simulating the end-to-end distribution and performance of a service assignment by an autonomous vehicle via a service entity infrastructure) according to example embodiments of the present disclosure. One or more portion(s) of the operations of method 500 can be implemented by one or more computing systems that include, for example, a vehicle computing system (e.g., vehicle computing system 112, etc.), one or more portions of an operations computing system (e.g., operations computing system 104, etc.), one or more remote computing systems (e.g., remote computing device 106, remote computing system 720, etc.), computing system 600, vehicle service test system 900, and/or one or the like. Each respective portion of the method 500 can be performed by any (or any combination) of the computing device(s) of the respective computing system. Moreover, one or more portion(s) of the method 500 can be implemented as an algorithm on the hardware components of the device(s) described herein (e.g., as in FIGS. 1, 6, 7, and 9), for example, to facilitate offboard vehicle service testing. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 502, method 500 includes obtaining data indicative of an autonomous vehicle (e.g., a simulated autonomous vehicle, a representation of an actual autonomous vehicle operating in a real world environment (test track), etc.) to be tested within a simulation environment. For example, the OTT system can obtain data indicative of an autonomous vehicle (e.g., service entity vehicle, third-party vehicle, etc.) that is to be tested within a simulation environment associated with a service entity platform, for example, via a command line interface, a graphical user interface, a testing library, and/or the like. The OTT system can obtain data defining at least one instance of a simulated autonomous vehicle. In some examples, a user (e.g., a developer, etc.) may define the at least one instance of the simulated autonomous vehicle using one or more interfaces provided by the OTT system. In this manner, a user may provision a new simulated autonomous vehicle to be evaluated in accordance with one or more vehicle services. The data defining the at least one instance of the simulated autonomous vehicle may include data defining one or more capabilities of the autonomous vehicle, a state of the autonomous vehicle, etc.

At 504, method 500 includes generating a simulation environment for the simulation. For instance, the OTT system can include a simulation environment service that manages simulation environments. For example, the simulation environment service can be or otherwise include a simulation environment (e.g., sandbox) service that manages simulation environments (e.g., sandboxes). A sandbox can include an environment (e.g., a sandbox for simulating autonomous vehicle performance, etc.) that facilitates isolating tests and simulations from a production environment (e.g., real-world service assignment allocation and vehicle monitoring systems). The OTT system can generate (e.g., create, obtain, request, etc.) a simulation environment for the simulation. As described herein, the simulation environment (e.g., sandbox, etc.) can be configured to isolate the simulation from real-world service assignment allocation by the entity's infrastructure and can include the simulated actors (e.g., simulated user, simulated vehicle, etc.) to be utilized in the simulation. In some implementations, the entity (e.g., a human user or computing system associated therewith) can create or open an existing sandbox and configure a simulation within the simulation environment (e.g., via the graphic user interface, command line interface, etc.).

At 506, method 500 includes generating a simulated autonomous vehicle within the simulation environment (e.g., sandbox). For example, the OTT system can generate a simulated autonomous vehicle (e.g., based on obtained data, etc.) within the simulation environment (e.g., sandbox) to allow for testing the capabilities, performance, etc. of the autonomous vehicle with regard to service assignments. A simulated autonomous vehicle may include a simulation of any portion or all of an autonomous vehicle as described herein (e.g., with reference to FIG. 1). For example, an autonomy software stack of an autonomous vehicle or other computer-based systems of the autonomous vehicle can be simulated. One or more instances of a simulated autonomous vehicle can be provisioned and deployed at one or more computing devices. Data including one or more parameters associated with a vehicle service simulation can be obtained. A software developer can provide control commands and/or predefined simulation scenarios for the instance of the autonomous vehicle. Each of the one or more predefined simulation scenarios can be provided as a respective scenario object to the at least one instance of the simulated autonomous vehicle in example embodiments. One or more vehicle service simulations can be performed using the instance of the simulated autonomous vehicle and the one or more parameters. Data indicative of the vehicle service simulations can be generated and/or stored by the vehicle service test system. In this manner, a vehicle service-flow and/or autonomous vehicle can be quickly evaluated and debugged prior to actual deployment of an autonomous vehicle in association with the vehicle service. In some examples, data can be exchanged using one or more testing libraries.

At 508, method 500 includes accessing one or more backend systems of the service entity, for example via a vehicle service platform, during the simulation. For example, the OTT system can provide for the simulator service to connect to a vehicle service platform (e.g., public vehicle integration platform outside of the executed test) using credentials obtained via a test third-party account, vehicle account, etc. In some implementations, the credentials can be provided when the third-party entity logs-in to access the OTT system. The OTT system can then access one or more backend systems of the service entity via the public API platform to obtain service assignment data, etc.

At 510, method 500 includes initiating the simulation of the autonomous vehicle within the simulation environment. For example, the OTT system can perform one or more vehicle service simulations using an instance of the simulated autonomous vehicle. A vehicle service simulation can include parameters that define a step (also referred to as a tick) duration, a vehicle movement strategy (e.g., no operation, move to pickup and drop-off locations, move using a constant speed and straight line, or move using a constant number of steps), vehicle callbacks (e.g., always reject, always accept, no operation), and/or a maximum number of steps. A vehicle service simulation can result in a termination condition in response to a vehicle entering a terminal state (e.g., vehicle is offline), a vehicle performing a terminating transition (e.g., door open), a termination command being executed, or a maximum number of steps being reached.

At 512, method 500 includes monitoring a performance of the simulated autonomous vehicle during the service simulation. For example, the OTT system can verify that the simulated vehicle reports its position in an expected location and a status of the simulated autonomous vehicle (e.g., that the simulated autonomous vehicle is online and available for a service assignment, etc.). The OTT system can assign a simulated service assignment to the simulated autonomous vehicle and can verify that the simulated autonomous vehicle can perform the simulated service assignment by, for example, verifying that the simulated autonomous vehicle has an itinerary associated with a simulated user (e.g., by matching an identifier).

As the simulated autonomous vehicle navigates to the simulated user, the OTT system can monitor the performance of the simulated service assignment by the simulated autonomous vehicle. For example, the OTT system can determine that the simulated autonomous vehicle is travelling to the origin location of the simulated user, that the simulated autonomous vehicle has arrived at the origin location of the simulated user (e.g., within a certain time), that the simulated autonomous vehicle has arrived at the destination location of the simulated user (e.g., within a certain time), etc. Additionally, or alternatively, the OTT system can identify intermediate states (e.g., of the itinerary, the simulated autonomous vehicle, etc.) during the simulation of the vehicle service. During the performance of the simulated service assignment, the simulated autonomous vehicle may have access to the one or more services of the one or more backend systems of the service entity (e.g., routing, etc.). This can allow the simulation to test the communications between the simulated autonomous vehicle and the backend services of the entity's infrastructure. After the simulation is complete (e.g., the autonomous vehicle arrives at the destination location, etc.), the vehicle can be disconnected from the public API platform and deactivate the simulation environment (e.g., sandbox) associated with the simulation.

At 514, method 500 includes providing data indicative of the simulation, for example, for display via a graphical user interface, etc. For example, the OTT system can provide one or more graphical user interfaces (e.g., a web interface, etc.) to visualize simulated service assignments, simulated vehicle status, and/or other information (e.g., logs, metrics, etc.) associated with the autonomous vehicle service simulation, thereby allowing for analyzing the performance of the simulated autonomous vehicle.

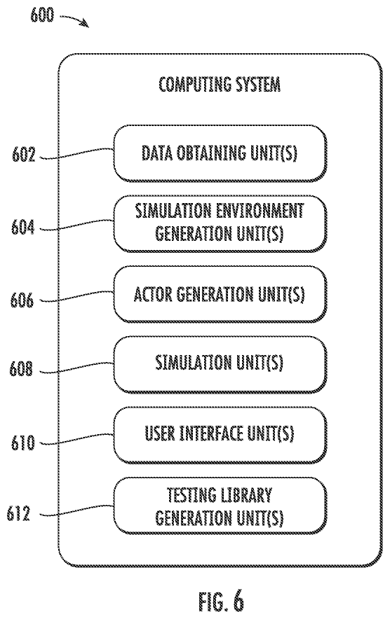

Various means can be configured to perform the methods and processes described herein. For example, FIG. 6 depicts a diagram of an example computing system 600 that includes various means according to example embodiments of the present disclosure. The system 600 can include data obtaining unit(s) 602, simulation environment (e.g., sandbox) generation unit(s) 604, actor generation unit(s) 606, simulation unit(s) 608, user interface unit(s) 610, testing library data generation unit(s) 612, and/or other means for performing the operations and functions described herein. In some implementations, one or more of the units may be implemented separately. In some implementations, one or more units may be a part of or included in one or more other units.

These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. The methods (e.g., method 500, method 800) and/or other operations described herein can be implemented as such algorithm(s). For instance, the means (e.g., data obtaining unit(s) 602, user interface unit(s) 610) can be configured to obtain data indicative of an autonomous vehicle to be tested within a simulation associated with a service entity (e.g., tester account data, vehicle account data, vehicle autonomy capability data, etc.). The means (e.g., simulation environment generation unit(s) 604) can be configured to generate a simulation environment (e.g., sandbox) for the simulation. The means (e.g., actor generation unit(s) 606) can be configured to generate actors (e.g., simulated users, simulated vehicles, etc.) for the simulation. For example, the means (e.g., actor generation unit(s) 606) can be configured to generate a simulated user, a simulated autonomous vehicle, and/or other actor(s) within the simulation environment. The means (e.g., simulation unit(s) 608) can access one or more backend systems of the service entity via an application programming interface platform having one or more functional calls defined to be accessed by a third-party autonomous vehicle or a managing entity of third-party autonomous vehicles.

The means (e.g., simulation unit(s) 608) can initiate the simulation of the simulated autonomous vehicle within the simulation environment (e.g., sandbox), as described herein. The means (e.g., simulation unit(s) 608) can provide the simulated autonomous vehicle access to one or more services of the one or more backend systems of the service entity during the simulation. The means (e.g., simulation unit(s) 608, user interface unit(s) 610, testing library data generation unit(s) 612, etc.) can be configured to obtain test scenario data indicative of simulation parameters. The means (e.g., simulation unit(s) 608, testing library data generation unit(s) 612) can be configured to generate simulation control data based on test scenario data. The means (e.g., simulation unit(s) 608, testing library data generation unit(s) 612) can be configured to provide simulation control data to run one or more simulations. The means (e.g., simulation unit(s) 608, user interface unit(s) 610, testing library data generation unit(s) 612) can be configured to obtain and/or generate simulation result data.

The means (e.g., simulation unit(s) 608, user interface unit(s) 610) can be configured to provide and/or display data associated with the simulations(s), for example, data indicative of the simulation environment, the simulated autonomous vehicle, the simulated actor(s), the simulated geographic area, the progress and/or performance of the simulated autonomous, log data, state data, timing data and/or other performance data.

These described functions of the means are provided as examples and are not meant to be limiting. The means can be configured for performing any of the operations and functions described herein.

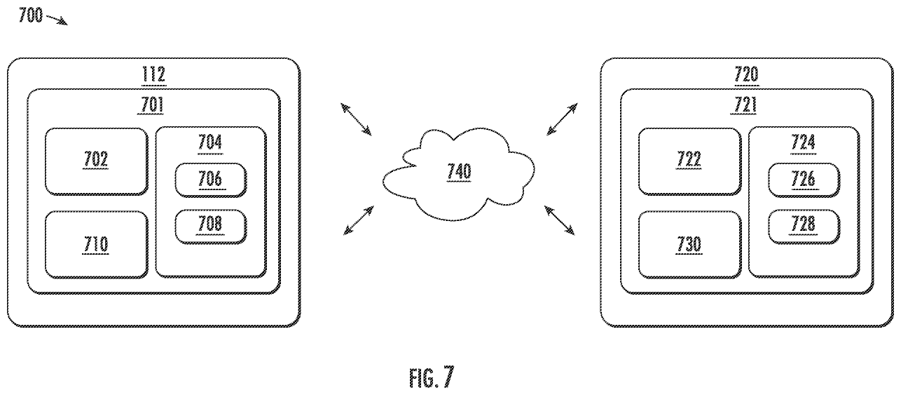

FIG. 7 depicts a block diagram of an example computing system 700 according to example embodiments of the present disclosure. The example system 700 illustrated in FIG. 7 is provided as an example only. The components, systems, connections, and/or other aspects illustrated in FIG. 7 are optional and are provided as examples of what is possible, but not required, to implement the present disclosure. As one example, the example system 700 can include the vehicle computing system 112 of the autonomous vehicle 102 and a remote computing system 720 (e.g., operations computing system, other computing system, etc. that is remote from the vehicle 102/vehicle computing system 112) that can be communicatively coupled to one another over one or more network(s) 740. The remote computing system 720 can be and/or include the operations computing system 104 and/or remote computing system 106 of FIG. 1, as an example. The remote computing system 720 can be associated with a central operations system and/or an entity associated with the vehicle 102 such as, for example, a vehicle owner, vehicle manager, fleet operator, service provider, etc. For instance, the remote computing system 720 can be or otherwise include the remote computing system 104 described herein.

The computing device(s) 701 of the vehicle computing system 112 can include processor(s) 702 and at least one memory 704. The one or more processors 702 can be any suitable processing device (e.g., a processor core, a microprocessor, an ASIC, a FPGA, a controller, a microcontroller, etc.) and can be one processor or a plurality of processors that are operatively connected. The memory 704 can include one or more non-transitory computer-readable storage media, such as RAM, ROM, EEPROM, EPROM, one or more memory devices, flash memory devices, magnetic disks, data registers, etc., and combinations thereof.

The memory 704 can store information that can be accessed by the one or more processors 702. For instance, the memory 704 (e.g., one or more non-transitory computer-readable storage mediums, memory devices) can include computer-readable instructions 706 that can be executed by the one or more processors 702. The instructions 706 can be software written in any suitable programming language or can be implemented in hardware. Additionally, or alternatively, the instructions 706 can be executed in logically and/or virtually separate threads on processor(s) 702.

For example, the memory 704 on-board the vehicle 102 can store instructions 706 that when executed by the one or more processors 702 cause the one or more processors 702 (e.g., in the vehicle computing system 112) to perform operations such as any of the operations and functions of the computing device(s) 701 and/or vehicle computing system 112, any of the operations and functions for which the vehicle computing system 112 is configured, and/or any other operations and functions described herein.

The memory 704 can store data 708 that can be obtained (e.g., received, accessed, written, manipulated, created, generated, etc.) and/or stored. The data 708 can include, for instance, services data (e.g., assignment data, route data, user data, etc.), sensor data, map data, perception data, prediction data, motion planning data, object states and/or state data, object motion trajectories, feedback data, fault data, log data, and/or other data/information as described herein. In some implementations, the computing device(s) 701 can obtain data from one or more memories that are remote from the autonomous vehicle 102.

The computing device(s) 701 can also include a communication interface 710 used to communicate with one or more other system(s) (e.g., the remote computing system 720). The communication interface 710 can include any circuits, components, software, etc. for communicating via one or more networks (e.g., network(s) 740). In some implementations, the communication interface 710 can include, for example, one or more of a communications controller, receiver, transceiver, transmitter, port, conductors, software, and/or hardware for communicating data.

The remote computing system 720 can include one or more computing device(s) 721. The computing device(s) 721 can include one or more processors 722 and at least one memory 724. The one or more processors 722 can be any suitable processing device (e.g., a processor core, a microprocessor, an ASIC, a FPGA, a controller, a microcontroller, etc.) and can be one processor or a plurality of processors that are operatively connected. The memory 724 can include one or more tangible, non-transitory computer-readable storage media, such as RAM, ROM, EEPROM, EPROM, one or more memory devices, flash memory devices, data registers, etc., and combinations thereof.

The memory 724 can store information that can be accessed by the one or more processors 722. For instance, the memory 724 (e.g., one or more tangible, non-transitory computer-readable storage media, one or more memory devices, etc.) can include computer-readable instructions 726 that can be executed by the one or more processors 722. The instructions 726 can be software written in any suitable programming language or can be implemented in hardware. Additionally, or alternatively, the instructions 726 can be executed in logically and/or virtually separate threads on processor(s) 722.

For example, the memory 724 can store instructions 726 that when executed by the one or more processors 722 cause the one or more processors 722 to perform operations such as any of the operations and functions of the operations computing system 104, the remote computing system 106, the remote computing system 720 and/or computing device(s) 721 or for which any of these computing systems are configured, as described herein, and/or any other operations and functions described herein.

The memory 724 can store data 728 that can be obtained and/or stored. The data 728 can include, for instance, services data (e.g., assignment data, route data, user data etc.), data associated with autonomous vehicles (e.g., vehicle data, maintenance data, ownership data, sensor data, map data, perception data, prediction data, motion planning data, object states and/or state data, object motion trajectories, feedback data, fault data, log data, etc.), third-party entity data, inventory data, scheduling data, log data, attribute data, scenario data, simulation data (e.g., simulation control data, simulation result data, etc.), testing data, training data, integration data, libraries, user data, and/or other data/information as described herein. In some implementations, the computing device(s) 721 can obtain data from one or more memories that are remote from the remote computing system 720.

The computing device(s) 721 can also include a communication interface 730 used to communicate with one or more other system(s) (e.g., the vehicle computing system 112, remote computing systems, etc.). The communication interface 730 can include any circuits, components, software, etc. for communicating via one or more networks (e.g., network(s) 740). In some implementations, the communication interface 730 can include, for example, one or more of a communications controller, receiver, transceiver, transmitter, port, conductors, software, and/or hardware for communicating data.

The network(s) 740 can be any type of network or combination of networks that allows for communication between devices. In some embodiments, the network(s) 740 can include one or more of a local area network, wide area network, the Internet, secure network, cellular network, mesh network, peer-to-peer communication link, and/or some combination thereof, and can include any number of wired or wireless links. Communication over the network(s) 740 can be accomplished, for instance, via a communication interface using any type of protocol, protection scheme, encoding, format, packaging, etc.

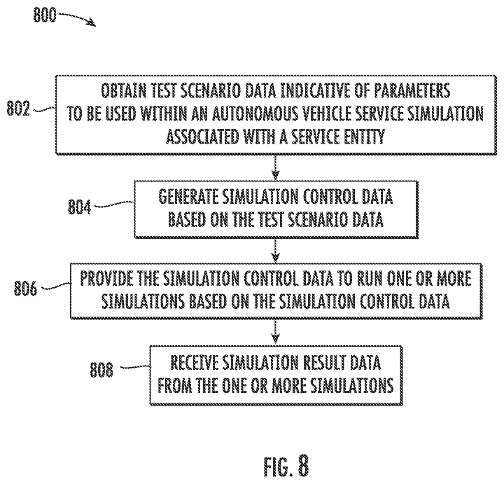

FIG. 8 depicts a flow diagram of an example method 800 for offboard vehicle service testing with testing libraries according to example embodiments of the present disclosure. One or more portion(s) of the operations of method 800 can be implemented by one or more computing systems that include, for example, a vehicle computing system (e.g., vehicle computing system 112, etc.), one or more portions of an operations computing system (e.g., operations computing system 104, etc.), one or more remote computing systems (e.g., remote computing device 106, remote computing system 720, etc.), computing system 600, vehicle service test system 900, and/or one or the like. Each respective portion of the method 800 can be performed by any (or any combination) of the computing device(s) of the respective computing system. Moreover, one or more portion(s) of the method 800 can be implemented as an algorithm on the hardware components of the device(s) described herein (e.g., as in FIGS. 1, 6, 7, and 9), for example, to facilitate offboard vehicle service testing. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 802, method 800 includes obtaining test scenario data indicative of parameters to be used within an autonomous vehicle service simulation associated with a service entity via one or more testing libraries. For example, one or more testing libraries can be provided that can facilitate the programmatic development of test scenario data and which can interface with the OTT system to allow for large scale simulation of autonomous vehicle services through the OTT system. The OTT system can include one or more interfaces configured to obtain test scenario data that is generated programmatically by code incorporating these libraries. As an example, one or more testing libraries can be used by a third-party developer to generate data for a simulation of a third-party autonomous vehicle. The testing libraries can obtain data associated with generating (e.g., creating, requesting, etc.) a simulation environment (e.g., sandbox) and generating a particular set of test actors, such as simulated third-party autonomous vehicle A and simulated rider A who will request a vehicle service in geographic area A (e.g., neighborhood, city, etc. where simulated third-party autonomous vehicle A may be expected to operate).

At 804, method 800 includes generating simulation control data based on the test scenario data. A testing library can provide abstractions of a service entity's infrastructure endpoints that allow a developer to develop autonomous vehicle testing scenarios that provide for running simulations on a large scale and/or frequent basis. For example, a developer can create testing library scenarios that will simulate service assignment flows and assert expected assignment results and/or autonomous vehicle behavior. In an example, the testing libraries can facilitate generating simulation control data to provide for positioning of the simulated third-party autonomous vehicle A within geographic area A, setting a location for simulated rider A within geographic area A, and/or the like. The testing libraries can facilitate generating simulation control data to establish a service assignment flow for simulated third-party autonomous vehicle A and expected assignment results and/or behavior.

At 806, method 800 includes providing the simulation control data to run one or more simulations based on the simulation control data. For example, a test library can interact with the OTT system to provide data in a form expected by the OTT system to run simulations based on the testing scenarios. As an example, the testing libraries can facilitate providing for running the simulation, including having simulated rider A perform a service request, simulated third-party autonomous vehicle A accepting the request and receiving service assignment data (e.g., itinerary, routing, etc.), navigating to the location of simulated rider A for the pickup, navigating to the destination, and completing the service assignment.

At 808, method 800 includes receiving simulation result data from the one or more simulations. For example, the OTT system can monitor the performance of the simulated autonomous vehicle while running simulation based on the simulation control data (e.g., simulated autonomous vehicle status, simulated assignment performance, simulated autonomous vehicle communications with service platform, etc.). The OTT system can then provide simulation result data indicative of such performance back to a system that receives the simulation result data programmatically through one or more testing libraries. In an example, the testing libraries can obtain data from the OTT system with regard to the third-party autonomous vehicle A reporting of position and status before, during, and/or after the service assignment as well as behavior of various test actors in the simulation and provide the data for use (e.g., analysis, etc.) by users (e.g., developers) at a third-party system.

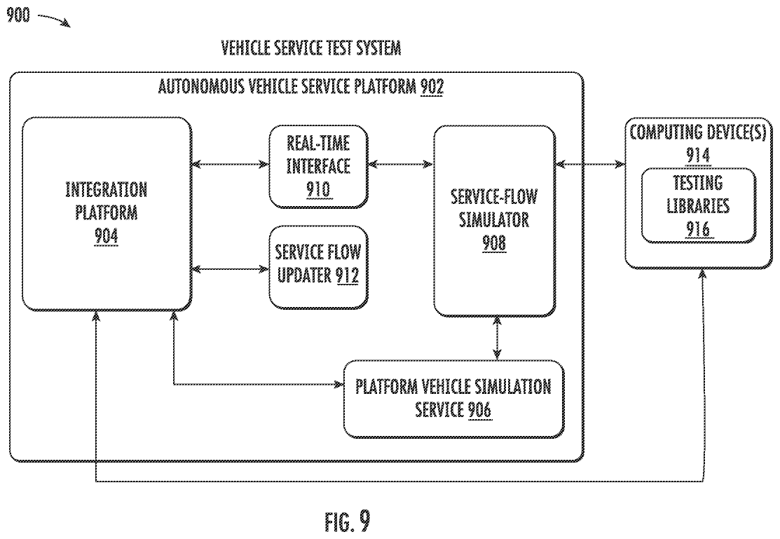

FIG. 9 depicts an example vehicle service test system 900 according to example embodiments of the present disclosure. A vehicle service test system, as illustrated in FIG. 9, can provide for evaluation of autonomous vehicle services through computer-implemented simulations of vehicle service-flows that utilize autonomous vehicles. A vehicle service test system 900 can include an autonomous vehicle service platform 902, an integration platform 904, a platform vehicle simulation service 906, a service-flow simulator 908, a real-time interface 910, a service-flow updater 912, one or more remote computing devices 914, one or more testing libraries 916, and/or the like.

A vehicle service test system 900 can provide one or more interfaces that enable users (e.g., software developers for autonomous vehicle computing systems, etc.) to design and test vehicle services using simulated autonomous vehicles. Data defining a simulated autonomous vehicle can be obtained in response to input received from a user through the one or more user interfaces. Similarly, data indicative of one or more parameters for at least one vehicle service simulation can be obtained, for example, in response to input received from a user through the one or more user interfaces. The test system may obtain from a remote computing system a request for an autonomous vehicle simulation. The test system can initiate one or more vehicle service simulations using the one or more parameters and the simulated autonomous vehicle. In this manner, users can define and debug vehicle service-flows within a single set of user interfaces. A user can manually control a vehicle service-flow in some examples by controlling an autonomous vehicle state. In other examples, a user can automate control of the vehicle service-flow using one or more predefined simulation scenarios. By providing a simulated testing environment that provides developer control over vehicle service-flows as well as autonomous vehicle definition, a quick and efficient technique for designing and evaluating vehicle service-flows can be provided.

The vehicle service test system 900 can be associated with an autonomous vehicle service platform 902. The autonomous vehicle service platform 902 can be associated with a service entity infrastructure which allows a service entity to provide vehicle services (e.g., transportation services (rideshare service), courier services, delivery services, etc.), for example, through vehicles in one or more vehicle fleets (e.g., service entity vehicle fleet, third-party vehicle fleet, etc.). For example, the autonomous vehicle service platform 902 can facilitate the generation of service assignments (e.g., indicative of the vehicle service type, origin location, destination location, and/or other parameters) to be performed by vehicles (e.g., within a fleet) in response to requests for vehicle services (e.g., from a user).

The autonomous vehicle service platform 902 can include integration platform 904 configured to integrate autonomous vehicles (e.g., autonomous computing systems) with the autonomous vehicle service platform 902. In some examples, the integration platform 9004 is configured to integrate autonomous vehicles from different systems, such as from different vendors or providers of autonomous vehicles. The integration platform 904 enables multiple third-party systems to be integrated into a single autonomous vehicle service platform 902. Additionally, the integration platform 904 enables autonomous vehicles directly controlled by the operator of the autonomous vehicle service platform 902 to be integrated into a common service with autonomous vehicles from third-party systems.

The vehicle service test system 900 can include one or more vehicle simulation services. A vehicle simulation service can include one or more instances of a simulated autonomous vehicle. For instance, a vehicle simulation service can be provided at the autonomous vehicle service platform 902 as a platform vehicle simulation service 906 in some examples. Additionally and/or alternatively, a vehicle simulation service can be implemented at a computing device (e.g., computing device 914, etc.) remote from the autonomous vehicle service platform as a local vehicle simulation service for example.

In some examples, a platform vehicle simulation service 906 can be implemented at the autonomous vehicle service platform 902, such as at the same set of servers and/or within the same network used to implement the autonomous vehicle service 902, for example. Such a platform vehicle simulation service 906 can include one or more instances of a simulated autonomous vehicle. Each instance of the simulated autonomous vehicle can include an interface associated with the integration platform 904. A developer can provide data in association with the instance of the autonomous vehicle and data in association with the vehicle service simulation through the same interface. For example, a developer can access an interface for the simulator to initialize and/or modify a state of the simulated autonomous vehicle instance. Additionally, the same interface may be used to dispatch, accept, and simulate a vehicle service using the autonomous vehicle instance. In this manner, a developer can use a graphical user interface such as a browser interface rather than a command line interface for controlling an autonomous vehicle instance. The simulator may include a vehicle simulation service client configured to communicate with the platform vehicle simulation service 906. For example, the vehicle simulation service client can communicate with the platform vehicle simulation service 906 to accept vehicle service requests and control the autonomous vehicle instance. The state of the autonomous vehicle instance can be stored and updated in the simulator interface, and pushed to the platform vehicle simulation service 906. The platform vehicle simulation service 906 can be stateful and can route calls to the autonomous vehicle instance where the requested autonomous vehicle interface is running.

In some examples, a vehicle simulation service (e.g., platform vehicle simulation service 906) process may communicate with the integration platform 904 and simulation interfaces such as a service-flow simulator interface and/or vehicle simulator interface. In some examples, interfaces may be provided at one or more client computing devices (e.g., computing device 914, etc.). The vehicle simulation service process may include one or more endpoints (e.g., RPC end points) to facilitate communication with simulation interfaces (e.g., client computing devices using CLI and/or RPC).

The autonomous vehicle service platform 902 can include a service-flow simulator 908 configured as a tool for simulating service-flows using an autonomous vehicle. The vehicle service test system 900 can obtain data indicative of one or more parameters for at least one vehicle service simulation. The parameters for a vehicle service simulation may include parameters that define a vehicle service-flow. For example, data defining a vehicle service-flow may define a dispatch of a vehicle service to an instance of a simulated autonomous vehicle. Data defining the vehicle service-flow may also include data instructing the instance of the simulated autonomous vehicle to accept or reject the service request. The data may additionally include data indicative of service-flow updates and/or location updates. The data may indicate a route from a pick-up location to a drop-off location in example embodiments.

The autonomous vehicle service platform 902 can include a real-time interface 910 provided between the integration platform 904 and the service-flow simulator 908. A service request can be provided from the service-flow simulator 908 through the real-time interface 910 to the integration platform 904.

The autonomous vehicle service platform 902 can include a service-flow updater 912 that passes service-flow updates to and from the integration platform 904. Service-flow updates can be received at the integration platform 904 as a push notification from the service-flow updater 912. An update can be passed to the instance of the simulated autonomous vehicle corresponding to the service request. For example, an interface (e.g., SDK) inside the autonomous vehicle instance can establish a consistent connection (e.g., HTTP2) with the integration platform 904. A service request can be matched with the instance of the autonomous vehicle using a flag or other suitable identifier.

The vehicle service test system 900 can include one or more testing libraries 916 that can interface with the vehicle service test system 900 to provide for programmatically developing testing scenarios for running autonomous vehicle service simulations. For example, a developer can incorporate one or more testing libraries (e.g., a testing library 916) into code to programmatically control a test autonomous vehicle and/or vehicle service.

A testing library 916 can be used to interface with one or more simulation services and/or interface directly with an integration platform (e.g., integration platform 904). For example, one or more testing libraries (e.g., a testing library 916) may be used to interface with the autonomous vehicle service platform 902. In some examples, the vehicle service test system 900 may obtain data indicative of one or more parameters for at least one vehicle service simulation using one or more testing libraries (e.g., testing library 916). In some examples, service requests can be programmatically simulated via one or more testing libraries (e.g., testing library 916).

Instance(s) of a simulated autonomous vehicle can be deployed as a network service in some examples, such as at one or more servers in direct communication with the vehicle service test system 900. In other examples, the instances of the simulated autonomous vehicle can be deployed at a local computing device (e.g., computing device 914) remote from the vehicle service test system 900. The local computing device can be operated by the same entity that operates an autonomous vehicle service platform, or by a third-party entity. In either case, the vehicle service test system can communicate with the simulated autonomous vehicle instances using various communication protocols. In some examples, each instance of a simulated autonomous vehicle may include an interface such as an interface programmed in a software development kit (SDK) that is similar to or the same as an interface (e.g., SDK) included within an actual autonomous vehicle used to provide the vehicle service. The interface may enable the vehicle service test system to issue instructions to the autonomous vehicle instance to accept a service request, reject a service request, update the pose field of the autonomous vehicle instance, etc. In some examples, a user may deploy instances of a simulated autonomous vehicle using one or more test libraries (e.g., testing library 916).

Computing tasks, operations, and functions discussed herein as being performed at one computing system herein can instead be performed by another computing system, and/or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

The communications between computing systems described herein can occur directly between the systems or indirectly between the systems. For example, in some implementations, the computing systems can communicate via one or more intermediary computing systems. The intermediary computing systems may alter the communicated data in some manner before communicating it to another computing system.

The number and configuration of elements shown in the figures is not meant to be limiting. More or less of those elements and/or different configurations can be utilized in various embodiments.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for autonomous vehicle service assignment simulation, the method comprising:
obtaining, by a computing system comprising one or more computing devices, data indicative of an autonomous vehicle to be tested within a simulation associated with a service entity;
generating, by the computing system, a simulation environment for the simulation;
generating, by the computing system, an autonomous vehicle within the simulation environment based at least in part on the data indicative of the autonomous vehicle;
accessing, by the computing system, one or more backend systems of the service entity via an application programming interface platform having one or more functional calls defined to be accessed by a third-party autonomous vehicle or a managing entity of third-party autonomous vehicles;
initiating, by the computing system, the simulation of the autonomous vehicle within the simulation environment; and
providing, by the computing system, the autonomous vehicle access to one or more services of the one or more backend systems of the service entity during the simulation.

2. The computer-implemented method of claim 1, wherein the simulation environment is a sandbox that is configured to isolate the simulation from a real-world service assignment allocation by the service entity.

3. The computer-implemented method of claim 1, wherein initiating the simulation of the autonomous vehicle comprises:
generating, by the computing system, a simulated service assignment for the autonomous vehicle to perform within a simulated geographic area; and
assigning, by the computing system, the simulated service assignment to the autonomous vehicle.

4. The computer-implemented method of claim 1, wherein initiating the simulation of the autonomous vehicle comprises:
generating, by the computing system, a simulated user for transportation by the autonomous vehicle within the simulated geographic area;
obtaining, by the computing system, data indicative of a simulated service request associated with the simulated user; and
generating, by the computing system, the simulated service assignment based at least in part on the simulated service request associated with the simulated user.

5. The computer-implemented method of claim 4, wherein the simulated service request comprises an origin location of the simulated user and a destination location of the simulated user within a simulated geographic area, and wherein the simulated service assignment is based on the origin location and the destination location.

6. The computer-implemented method of claim 5, further comprising:
monitoring, by the computing system, a performance of the simulated service assignment by the autonomous vehicle within the simulated geographic area.

7. The computer-implemented method of claim 6, wherein monitoring the performance of the simulated service assignment by the autonomous vehicle comprises:
determining, by the computing system, that the autonomous vehicle is travelling to the origin location of the simulated user;
determining, by the computing system, that the autonomous vehicle has arrived at the origin location of the simulated user; and
determining, by the computing system, that the autonomous vehicle has arrived at the destination location of the simulated user.

8. The computer-implemented method of claim 5, further comprising:
identifying, by the computing system, a location of the autonomous vehicle within the simulated geographic area and a status of the autonomous vehicle, wherein the status indicates an availability of the autonomous vehicle to perform a simulated service assignment.

9. The computer-implemented method of claim 1, further comprising:
providing, by the computing system, data indicative of the simulation for display via a user interface of a display device.

10. The computer-implemented method of claim 1, wherein obtaining data indicative of the autonomous vehicle to be tested within a simulation associated with a service entity comprises:
obtaining, by the computing system, test scenario data indicative of parameters to be used within the autonomous vehicle service assignment simulation associated with the service entity via one or more libraries;
generating, by the computing system, simulation control data based on the test scenario data; and
providing, by the computing system, the simulation control data to run one or more simulations based on the simulation control data.

11. The computer-implemented method of claim 10, wherein obtaining the test scenario data indicative of parameters to be used within the autonomous vehicle service assignment simulation associated with the service entity, comprises:
obtaining, by the computing system, the test data scenario programmatically via one or more interfaces programmed in a software development kit.

12. The computer-implemented method of claim 10, further comprising providing, by the computing system, simulation result data from the one or more simulations via the one or more libraries.

13. A computing system comprising:
one or more processors; and
one or more tangible, non-transitory, computer readable media that collectively store instructions that when executed by the one or more processors cause the computing system to perform operations comprising:
generating a simulation environment for a simulation associated with a service entity;
generating a simulated user and an autonomous vehicle within the simulation environment;
providing the autonomous vehicle with access to one or more backend systems of the service entity via an application programming interface platform;
generating a simulated service assignment associated with the simulated user for the autonomous vehicle; and
initiating the simulation within the simulation environment, wherein the autonomous vehicle performs the simulated service assignment associated with the simulated user during the simulation and the autonomous vehicle has access to one or more backend systems of the service entity during the simulation.

14. The computing system of any of claim 13, wherein generating the simulated service assignment comprises:
obtaining data indicative of a simulated service request associated with the simulated user; and
generating the simulated service assignment based at least in part on the simulated service request associated with the simulated user.

15. The computing system of claim 14, wherein the simulated service request comprises an origin location of the simulated user and a destination location of the simulated user, and wherein the simulated service assignment is based on the origin location and the destination location.

16. The computing system of claim 15, further comprising:
monitoring a performance of the simulated service assignment by the autonomous vehicle.

17. The computing system of claim 16, wherein monitoring the performance of the simulated service assignment by the autonomous vehicle comprises:
determining that the autonomous vehicle is travelling to the origin location of the simulated user;
determining that the autonomous vehicle has arrived at the origin location of the simulated user; and
determining that the autonomous vehicle has arrived at the destination location of the simulated user.

18. The computing system of claim 17, wherein the operations further comprise:
providing data indicative of the simulation for display via a user interface of a display device.

19. The computing system of claim 13, wherein the operations further comprise:
obtaining simulation control data to run one or more simulations via one or more libraries, the simulation control data based at least in part on test scenario data indicative of parameters to be used within the service assignment simulation associated with the service entity.

20. A communication system, comprising:
a vehicle integration platform comprising one or more processors, the vehicle integration platform configured to facilitate message communication among a plurality of autonomous vehicles;
a vehicle service test system including one or more interfaces to facilitate autonomous vehicle service simulations within the vehicle integration platform, the vehicle service test system comprising an offboard trip testing system configured to generate a simulation environment for testing a simulated service assignment and a vehicle simulation service configured to provision a simulated autonomous vehicle for testing within the vehicle service test system; and
one or more interfaces configured to obtain test scenario data programmatically generated using a plurality of libraries associated with a plurality of programming languages, the test scenario data indicative of parameters to be used within an autonomous vehicle service assignment simulation of the vehicle service test system.
